(19) United States
(12) Patent Application Publication
(10) Pub. No.: US 2015/0378089 A1
(43) Pub. Date: Dec. 31, 2015

(54) BACKLIGHT UNIT AND LIQUID CRYSTAL DISPLAY DEVICE

(71) Applicant: FUJIFILM Corporation, Tokyo (JP)

(72) Inventors: Tatsuya OBA, Kanagawa (JP); Makoto KAMO, Kanagawa (JP)

(73) Assignee: FUJIFILM Corporation, Tokyo (JP)

(21) Appl. No.: 14/751,832

(22) Filed: Jun. 26, 2015

(30) Foreign Application Priority Data
Jun. 27, 2014 (JP) 2014-133363
Dec. 3, 2014 (JP) 2014-245205
May 15, 2015 (JP) 2015-099718

(51) Int. Cl. F21V 8/00; G02F 1/1335

(52) U.S. Cl. CPC G02B 6/0068; G02B 6/005; G02B 6/0055; G02B 6/0073; G02F 1/1336; G02F 2001/133614

(57) ABSTRACT

A backlight unit including a light-emitting element and a member that selectively reduces an amount of emitted light, and wherein the light-emitting element includes a light source and a wavelength conversion member, and the wavelength conversion member includes at least one fluorescent material, the light-emitting element has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm.

### CROSS-REFERENCE TO RELATED APPLICATIONS

This application claims priority under 35 U.S.C. 119 to Japanese Patent Application No. 2014-133363 filed on Jun. 27, 2014, Japanese Patent Application No. 2014-245205 filed on Dec. 3, 2014 and Japanese Patent Application No. 2015-099718 filed on May 15, 2015. Each of the above applications is hereby expressly incorporated by reference, in its entirety.

### BACKGROUND OF THE INVENTION

1. Field of the Invention

The present invention relates to a backlight unit and a liquid crystal display device including the backlight unit.

2. Discussion of the Background

Use of flat panel display such as a liquid crystal display device (hereinafter, also referred to as “LCD”) has been enlarged year by year as a space-saving image display device because of small power consumption. The liquid crystal display device is constituted of at least a backlight and a liquid crystal cell, and usually, further includes a polarizing plate on a backlight side, a polarizing plate on a viewing side.

Backlight units containing light sources in the form of white light sources such as white light-emitting diodes (LEDs) are widely employed. In contrast, in recent years, new backlight units have been proposed that achieve white light with light emitted by, for example, a light source such as a blue LED and light emitted by a wavelength conversion member, instead of a white light source. In these new backlight units, the wavelength conversion member is disposed as a separate member from the light source and contains fluorescent materials that are excited by light emitted by the light source to emit fluorescence (for example, see Japanese Unexamined Patent Publication (KOKAI) No. 2008-41706, which is expressly incorporated herein by reference in its entirety).

### SUMMARY OF THE INVENTION

In the above new backlight units, more specifically, white light can be achieved in the following manner, for example.

Light emitted by a light source enters a wavelength conversion member disposed on the optical path of the light. A fluorescent material is irradiated and excited with the light entering the wavelength conversion member. Light passing through the wavelength conversion member without irradiating a fluorescent material is emitted outside the wavelength conversion member (emitted light derived from the light source).

Additionally, the fluorescent material that has been excited emits light (fluorescence) of a different wavelength from the entering light. When a fluorescent material in the form of, for example, a yellow light-emitting fluorescent material (yellow fluorescent material) is employed, yellow light is emitted by the wavelength conversion member. When a green light-emitting fluorescent material (green fluorescent material) is employed, green light is emitted. And when a red light-emitting fluorescent material (red fluorescent material) is employed, red light is emitted. Thus, it is possible to obtain emitted light (additional emitted light) of differing wavelength from the emitted light derived from the light source. By mixing the emitted light derived from the light source and the additional emitted light, white light can be achieved. For example, the achieving of white light by mixing blue light in the form of emitted light derived from a light source, yellow light in the form of additional emitted light, and yellow light and red light in the form of additional emitted light, or additional emitted light in the form of green light and red light, is proposed in paragraph 0033 of Japanese Unexamined Patent Publication (KOKAI) No. 2008-41706. The achieving of white light by mixing light of various colors having respective single emission peaks is effective for expanding the color reproducibility range and to enhance the brightness (degree of brightness per unit area) on the display surface of a liquid crystal display device. Of these, the use of blue light, green light, and red light having center emission wavelengths in wavelength ranges selected by color filters in liquid crystal display devices is desirable from the perspective of increasing the brightness. This is because it makes it possible to reduce loss of light due to absorption by color filters.

Additionally, greater expansion of the color reproducibility range is being demanded to obtain liquid crystal display devices capable of displaying higher quality images. More specifically, greater expansion from 72% of the NTSC (National Television System Committee)) ratio is being demanded. In principle, the color reproducibility range can be enhanced the greater the sharpness of the emitted light peak (the narrower the half width) of the light of various colors emitted by the backlight unit. Thus, the use of a fluorescent material that emits fluorescence with a narrow half width of the emission peak is conceivable as one means of enhancing the color reproducibility range. Specific examples of fluorescent materials that emit fluorescence of narrow half width are some nanoparticles containing cadmium (quantum dots, the details of which are given further below). However, they are generally expensive. Accordingly, the use of such fluorescent materials increases the cost of the backlight unit (and of the liquid crystal display device equipped with it), and thus ends up reducing the general usefulness of the above new backlight units.

Under such circumstances, there is a need for a new means of expanding the color reproducibility range without narrowing the half width of the emission peak of fluorescent materials.

An aspect of the present invention provides for a new means of expanding the color reproducibility range of a liquid crystal display device equipped with a backlight unit in which white light is achieved by mixing the three colors of blue light, green light, and red light.

As set forth above, in principle, the color reproducibility range can be further expanded by narrowing the emitted light peaks of the various colors of light emitted by the backlight unit. Thus, as a means of expanding the color reproducibility range, providing a filter layer that selectively removes (by absorption, for example) light between the emission center wavelength of blue light and the emission center wavelength of green light, or light between the emission center wavelength of green light and the emission center wavelength of red light, would conceivably narrow the half width of the emitted light peak of the blue light, green light, and red light that are emitted by a backlight unit. However, with such a means, even if it were possible to expand the color reproducibility range, the portion removed by the filter layer would decrease light use efficiency. As a result, the brightness of the image displayed on the display surface would end up decreasing. The advantage of being able to increase the brightness by achieving white light by mixing the three colors of blue light, green light, and red light would be lost.

The present inventors considered the above points and conducted extensive research. As a result, they discovered the following backlight unit:

a backlight unit, which comprises:

at least a light-emitting element and a member that selectively reduces an amount of emitted light (also referred to as “the member selectively reducing an amount of emitted light”, hereinafter); and wherein

the light-emitting element comprises a light source and a wavelength conversion member, and the wavelength conversion member comprises at least one fluorescent material having a property of being excited with exciting light to emit fluorescence;

the light-emitting element has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm; with at least the green light and the red light being emitted by the fluorescent material; and

the member that selectively reduces an amount of emitted light is positioned on an optical path of the light emitted by the light-emitting element and has a capability of selectively reducing an amount of emitted light in a wavelength range of 680 nm to 730 nm in the light that is emitted by the light-emitting element and enters the member that selectively reduces an amount of emitted light.

That is, the above backlight unit was discovered by the present inventors to be able to expand the color reproducibility range without causing a large drop in brightness in a liquid crystal display device. A more detailed description will be given below.

The above light-emitting element emits various lights having an emission intensity peak in the above three wavelength ranges. In the emission spectrum of the white light source, an emission peak is normally not present in the red light wavelength range. In light emitted by a backlight unit equipped with such a light-emitting element, light of the above wavelength range (680 nm to 730 nm) on the side of the wavelength longer than the emission center wavelength of the red light emitted by the fluorescent material can be selectively removed to permit narrowing of the half width of the red light. It thus becomes possible to expand the color reproducibility range. In addition, the removal of light on the shorter wavelength side than this wavelength range decreases the brightness as set forth above while the magnitude of the amount of light of the wavelength range on the longer wavelength side does not greatly change the brightness of the image that is sensed by the human eye. That is because the (visual) sensitivity of the human eye is extremely low for light in the long wavelength range at wavelengths greater than or equal to 680 nm. The brightness that is measured by a brightness meter is corrected in consideration of visual sensitivity so as to correspond to the brightness that is actually sensed by a person. Thus, even when the light in the wavelength range on the above long wavelength side is removed, the brightness measured by a brightness meter does not change greatly. That is, the selective removal of light in the wavelength range of 680 nm to 730 nm does not greatly change the brightness, making it possible to expand the color reproducibility range. This knowledge was obtained for the first time by the present inventors as the result of extensive research into discovering a means of expanding the color reproducibility range when achieving white light by mixing the three colors of blue light, green light, and red light.

Narrowing of the half width of red light as set forth above can effectively enhance the color reproducibility of images in a warm color system. More specifically, to display a sharp image in a warm color system on the display surface of a liquid crystal display device, it is desirable to narrow the half width of red light.

In one embodiment, the above backlight unit further comprises a selective reflection member on the optical path of light emitted by the light-emitting element. The selective reflection member has a reflection peak in a wavelength range of at least either the wavelength range between the emission center wavelength of blue light and the emission center wavelength of green light (also referred to as “reflection wavelength range 1”, hereinafter) or the wavelength range between the emission center wavelength of green light and the emission center wavelength of red light (also referred to as “reflection wavelength range 2”, hereinafter). The term “reflection peak” refers to a reflection maximum in the wavelength range of at least part of the reflection spectrum, and is not necessarily limited to the wavelength (maximum reflection wavelength) of greatest reflectance in the entire region of the reflection spectrum. This also applies to the absorption maximum described further below. The reflection peak can be determined from the minimum absorption wavelength in the transmission spectrum. Conversely, the absorption maximum can be determined from the minimum reflection wavelength in the reflection spectrum.

Positioning a selective reflection member having the reflection peak set forth above on the optical path of the light emitted by the light-emitting element, that is, on the emission side, makes it possible to cause light in the wavelength range of reflection wavelength range 1 and light in the wavelength range of reflection wavelength range 2 emitted by the light-emitting element to reflect to the side of the light-emitting element and to enter the light-emitting element. The fluorescent materials contained in the light-emitting element is irradiated and excited with the light thus entering, thereby making it possible to achieve new light emission (fluorescence). Removing the light of reflection wavelength ranges 1 and/or 2 makes it possible to narrow the emitted light peaks of the light of various colors emitted by the backlight unit, thereby making it possible to narrow the half width of the emitted light in the light (red light and/or green light) emitted by the fluorescent materials. Although simple removal may invite a drop in brightness as set forth above, using this as excitating light to achieve new light emission as set forth above makes it possible to further expand the color reproducibility range without inviting a large decrease in brightness. The reflecting of a portion of the light emitted by the light-emitting element, causing it to re-enter the light-emitting element, and using it to excite a fluorescent material is described in Japanese Unexamined Patent Publication (KOKAI) No. 2008-287073. However, Japanese Unexamined Patent Publication (KOKAI) No. 2008-287073 discloses this as the topic of enhancing the use efficiency of light emitted by a white light source (see paragraph 0006 of Japanese Unexamined Patent Publication (KOKAI) No. 2008-287073, which is expressly incorporated herein by reference in its entirety), and does not provide even a suggestion of the present invention the topic of which is expanding the color reproducibility range of a liquid crystal display device equipped with the above new backlight unit.

In one embodiment, the member that selectively reduces the amount of emitted light and the selective reflection member are separate members, and in another embodiment, a single member.

In one embodiment, the member that selectively reduces the amount of emitted light has a capability of selectively absorbing light in the wavelength range of 680 nm to 730 nm.

In one embodiment, the member that selectively reduces the amount of emitted light contains a dye that exhibits the capability of absorbing light in the wavelength range of 680 nm to 730 nm.

In one embodiment, the member that selectively reduces the amount of emitted light has a capability of selectively reflecting light in wavelength range of 680 nm to 730 nm.

In one embodiment, the member that selectively reduces the amount of emitted light is a multilayered film in which multiple layers of differing refractive index are laminated.

In one embodiment, the member that selectively reduces the amount of emitted light is a light-reflecting layer in which a cholesteric liquid crystal phase is fixed.

In one embodiment, in the backlight unit with the member that selectively reduces the amount of emitted light having the capability of selectively reflecting light set forth above, the light-emitting element further comprises a selective absorption member having a capability of selectively absorbing light in the wavelength range of 680 nm to 730 nm.

In one embodiment, the member that selectively reduces the amount of emitted light is integrally laminated with the wavelength conversion member. In this context, the term “integrally laminated” is used to exclude the state where the member that selectively reduces an amount of emitted light and the wavelength conversion member are simply disposed without coating or adhesion. For example, as set forth further below, the embodiment where the member that selectively reduces an amount of emitted light is contained in a barrier film employed as a base material in the course of forming the wavelength conversion layer by a coating method, the state where the member that selectively reduces an amount of emitted light and the wavelength conversion member are tightly bonded by an intermediate layer that bonds the two members, the state where the two members are tightly bonded by lamination processing employing an adhesive or by lamination processing (hot pressure bonding) not employing an adhesive, and the like are all included in “integrally laminated.”

In one embodiment, the fluorescent material comprises at least one quantum dot.

In one embodiment, the fluorescent material comprises at leas one ceramic fluorescent material.

In one embodiment, the light source is a light source that emits single peak light.

In one embodiment, the light source is a blue light source emitting blue light.

A further aspect of the present invention relates to a liquid crystal display device comprising at least the above backlight unit and a liquid crystal cell.

An aspect of the present invention can expand the color reproducibility range without inviting a large drop in brightness in a liquid crystal display device equipped with a new backlight unit achieving white light by mixing the three colors of blue light, green light, and red light.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the drawing, wherein:

FIG. 1A is an explanatory view showing one example of the light-emitting element contained in the backlight unit according to an aspect of the present invention.

FIG. 1B is an explanatory view showing one example of the light-emitting element contained in the backlight unit according to an aspect of the present invention.

FIG. 2 is a schematic configuration diagram of one example of an apparatus of manufacturing a wavelength conversion member.

FIG. 3 is a partially enlarged view of the manufacturing apparatus shown in FIG. 2.

FIG. 4 shows one example of a liquid crystal display device according to an aspect of the present invention.

FIG. 5 shows a schematic drawing of the configuration of the liquid crystal display devices of Examples 1 to 3, 6 to 8, 11 to 13, 16 to 18, and 21 and Comparative Examples 1 to 6.

FIG. 6 shows a schematic drawing of the configuration of the liquid crystal display devices of Examples 4, 9, 14, and 19.

FIG. 7 shows a schematic drawing of the configuration of the liquid crystal display devices of Examples 5, 10, 15, and 20.

### DETAILED DESCRIPTION OF THE EMBODIMENTS

In the following, explanation may be carried out on the basis of typical embodiments of the present invention, but the present invention is not limited to these embodiments. In the present invention and the description, the numerical range represented by “to” means the range including the numerical values before and after the “to” as the upper limit and the lower limit.

In the present invention and the description, a “half width” of a peak means a width of the peak at ½ height of the peak. Light having an emission center wavelength within a wavelength range of 430 nm to 480 nm is referred to as blue light, light having an emission center wavelength within a wavelength range of 520 nm to 560 nm is referred to as green light, light having an emission center wavelength within a wavelength range of 600 nm to 680 nm is referred to as red light.

In the present invention and the description, unless specifically stated otherwise, the “group” in an alkyl group or the like can be substituted or unsubstituted. The number of carbon atoms in the case of a group for which the number of carbon atoms is given means the number of carbon atoms including those contained in substituents. When a given group has a substituent, examples of the substituent are alkyl groups (such as alkyl groups having 1 to 6 carbon atoms), hydroxyl group, alkoxy groups (such as alkoxy groups having 1 to 6 carbon atoms), halogen atoms (such as fluorine atoms, chlorine atoms, and bromine atoms), cyano groups, amino groups, nitro groups, acyl groups, and carboxy groups.

In the present invention and the description, a “polymerizable composition” is a composition containing at least one polymerizable compound, and has a property of being cured by being subjected to polymerization treatment such as light irradiation and heating. In addition, a “polymerizable compound” is a compound containing one or more polymerizable groups in one molecule. The polymerizable group is a group capable of being involved in a polymerization reaction. Details will be explained below.

### Backlight Unit

The backlight unit according to an aspect of the present invention comprises at least a light-emitting element and a member that selectively reduces an amount of emitted light. The light-emitting element comprises a light source and a wavelength conversion member, and the wavelength conversion member comprises at least one fluorescent material having a property of being excited with exciting light to emit fluorescence. The light-emitting element has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm, with at least the green light and the red light being emitted by the fluorescent material. The member that selectively reduces an amount of emitted light is positioned on an optical path of the light emitted by the light-emitting element and has a capability of selectively reducing an amount of emitted light in the wavelength range of 680 nm to 730 nm in the light that is emitted by the light-emitting element and enters the member that selectively reduces an amount of emitted light.

The above backlight unit will be described in greater detail below.

<Light-Emitting Element>

### (Light-Emitting Characteristics of the Light-Emitting Element)

The light-emitting element contained in the above backlight unit has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm. It is possible to achieve white light by mixing light of the three colors of blue light, green light, and red light in this manner. At least the green light and the red light are emitted by fluorescent materials and their half width exceeds 50 nm. As stated above, fluorescent materials emitting light with a narrow half width (such as less than or equal to 50 nm) exist. However, an aspect of the present invention makes it possible to expand the color reproducibility range without relying on such fluorescent materials and without a large reduction in brightness. Details of the means of expanding the color reproducibility range will be given further below. The half width of the various colors of light obtained by the emission of fluorescence is, for example, less than or equal to 150 nm, or less than or equal to 100 nm. The half width of the blue light can be less than or equal to 50 nm, or can exceed 50 nm. In one embodiment, the blue light is emitted by a light source. In another embodiment, it is emitted by a fluorescent material contained in the wavelength conversion member. In the former embodiment, a portion of the blue light that is emitted by the light source and enters the light conversion member becomes fluorescent material-exciting light in the wavelength conversion member, while another portion passes through the wavelength conversion member and is emitted outside the wavelength conversion member. The light thus emitted becomes the blue light that is emitted by the light-emitting element. In that case, the half width of the blue light is desirably less than or equal to 50 nm, preferably less than or equal to 40 nm, more preferably less than or equal to 30 nm, or, for example, greater than or equal to 10 nm. In the latter embodiment, for example, ultraviolet light emitted by a light source emitting ultraviolet light, described farther below, and entering the wavelength conversion member excites the fluorescent material, causing the fluorescent material to emit blue light. In that case, from the perspective of not relying on fluorescent material with a narrow half width, the half width of the blue light desirably exceeds 50 nm, is less than or equal to 150 nm, for example, or is less than or equal to 100 nm

(Configuration of the Light-Emitting Element)

An example of a specific embodiment of the light-emitting element contained in the above backlight unit will be described based on the drawings. However, the present invention is not limited to the following embodiments.

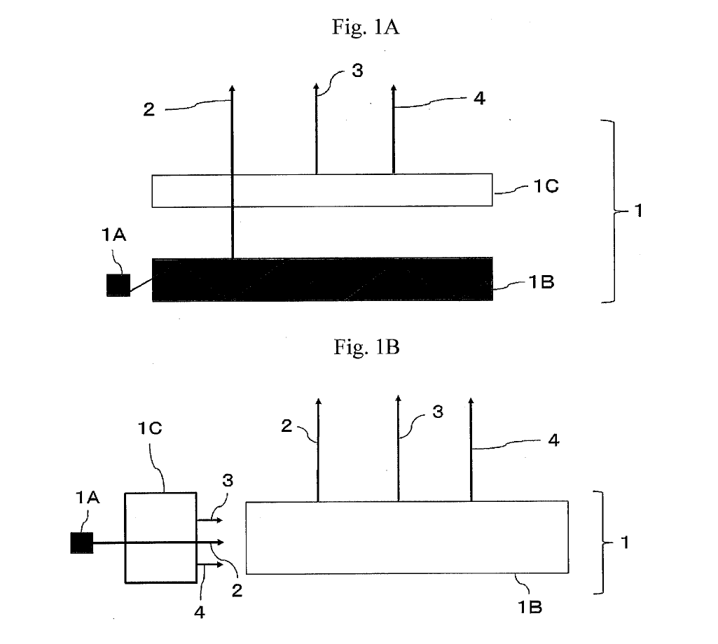

FIGS. 1A and 1B are descriptive drawings of the light-emitting element 1. In FIGS. 1A and 1B, light-emitting element 1 is equipped with a light source 1A and a light guide plate 1B for achieving a planar light source. In the example given in FIG. 1A, wavelength conversion member 1C is disposed on the optical path of the light emitted by the light guide plate. In the example given in FIG. 1B, wavelength conversion member 1C is disposed between the light guide plate and the light source.

In the example given in FIG. 1A, light emitted by light guide plate 1B enters wavelength conversion member 1C. In the example given in FIG. 1A, the light 2 emitted by light source 1A positioned on the edge portion of light guide plate 1B is blue light, and exits toward the liquid crystal cell from the surface on the liquid crystal cell (not shown) side of light guide plate 1B. At least a fluorescent material excited with blue light 2 and emitting green light 3 and a fluorescent material excited with blue light 2 and emitting red light 4 are contained in wavelength conversion member 1C disposed on the optical path of the light (blue light 2) emitted from light guide plate 1B. In this manner, red light 4 and green light 3 emitted by fluorescent materials and blue light 2 passing through wavelength conversion member 1C are emitted. Thus, white light can be achieved by emitting red light, green light, and blue light.

The example given in FIG. 1B is the same as the embodiment given in FIG. 1A, with the exception that wavelength conversion member 1C and light guide plate 1B are disposed differently. In the example given in FIG. 1B, excited green light 3 and red light 4 from wavelength conversion member 1C and blue light that has passed through wavelength conversion member 1C are emitted and enter light guide plate 1B, achieving a planar light source.

In the above description, the example is given of an embodiment in which blue light is emitted by the light source. However, the light source contained in the light-emitting element of the above backlight unit is not limited to emitting blue light. The details are given further below.

(Light Source)

The light source that is contained in the above light-emitting element emits single peak light, in one embodiment. In this context, the phrase “emits single peak light” means that two or more peaks do not appear in the emission spectrum, as is the case with white light, but just one peak is present, with the emission maximum wavelength as the emission center wavelength. In one embodiment, the monochrome light that is emitted by such a light source is mixed with light of another color that is emitted by a fluorescent material of the wavelength conversion member, thereby achieving white light. In a specific embodiment, a light source emitting blue light having an emission center wavelength in the wavelength range of 430 nm to 480 nm—for example, a blue light-emitting diode (blue LED)—can be used. When employing a blue light-emitting light source, at least a fluorescent material that is excited with exciting light and emits green light and a fluorescent material emitting red light are desirably contained in the wavelength conversion member. Thus, the blue light that is emitted by the light source and passes through the wavelength conversion member and the green light and red light that are emitted from the wavelength conversion member make it possible to achieve white light.

In another embodiment, a light source emitting ultraviolet light having an emission center wavelength in the wavelength range of 300 nm to 430 nm, such as an ultraviolet radiation-emitting diode, can be employed. In that case, at least a fluorescent material that is excited with exciting light and emits green light and a fluorescent material that is excited with exciting light and emits red light, as well as a fluorescent material that is excited with exciting light and emits blue light, are desirably contained in the wavelength conversion member. Thus, it is possible to achieve white light by means of blue light, green light, and red light emitted from the wavelength conversion member.

In yet another embodiment, a laser light source can be employed instead of a light-emitting diode.

In still another embodiment, there are also cases where a light source exhibiting two or more peaks in the emission spectrum is employed. An example of such a light source is a light source that has been imparted with an emission band with a longer wavelength region by adding a fluorescent material to the light source emitting single peak light set forth above. As a specific example, a trace amount of yellow fluorescent material is combined with a light-emitting element emitting blue light to achieve a light source (such as an LED) emitting blue light and yellow light. The term “yellow light” refers to light having an emission center wavelength in the wavelength range falling with a range of 570 nm to 585 nm.

(Wavelength Conversion Member)

### (i) Fluorescent Materials

At least a fluorescent material that is excited with exciting light and emits green light and a fluorescent material that is excited with exciting light and emits red light are contained in the wavelength conversion member. As set forth above, a fluorescent material that is excited with exciting light and emits blue light is also sometimes contained. Since these fluorescent materials are able to emit fluorescence with a different wavelength from the exciting light (perform wavelength conversion), the wavelength conversion member can emit light with a different wavelength from the entering light.

In one embodiment, the fluorescent material can be in the form of quantum dots (QDs, also known as quantum points), for example. Quantum dots, by way of example, are semiconductor crystal (semiconductor nanocrystal) particles of nano-order size, particles obtained by modifying the surface of a semiconductor nanocrystal with organic ligands, or particles obtained by covering the surface of semiconductor nano-crystals with a polymer layer. The emission wavelength of quantum dots can normally be adjusted by means of the particle composition, size, or the composition and size.

Examples of quantum dots are nanoparticles of semiconductor crystals such as ZnO, ZnS, ZnSe, ZnTe₃, MgS, MgSe, GaAs, GaN, GaP, GaSe, GaSb, InAs, InN, InP, InSb, AlAs, AlN, AlP, AlSb, TiN, TiP, TiAs, TiSb, and the like, and nanoparticles having a core-shell structure with one semiconductor crystal as a core and another semiconductor crystal as the shell. The particle serving as the core can be coated with a shell having a relatively broad band gap to greatly enhance quantum efficiency and obtain a quantum dot of high light-emitting efficiency. One embodiment of a quantum dot having a core-shell structure is a quantum dot having a core-multishell structure in which the shell is comprised of multiple layers. A quantum dot of even higher light-emitting efficiency can be obtained by laminating one or more layers of shells with narrow band gaps on a core with a broad band gap and then laminating a shell having a broad band gap over this shell.

Examples of quantum dots are those in which the surface of a semiconductor crystal particle is covered with organic ligands and those in which it is covered with a protective layer. Modification with organic ligands or covering with a protective layer can enhance the chemical stability of the quantum dot. Examples of organic ligands are pyridines, mercapto alcohols, thiols, phosphines, and phosphine oxides. Protective layers of epoxy, silicon, acrylic resins, glass, carbonate resins, and mixtures thereof can be employed.

The quantum dots set forth above can be synthesized by known methods or are available in the form of commercial products. For details, reference can be made by way of example to US 2010/123155A1, Japanese Translated PCT Patent Application Publication (TOKUHYO) No. 2012-509604, U.S. Pat. No. 8,425,803, Japanese Unexamined Patent Publication (KOKAI) No. 2013-136754, WO 2005/022120, Japanese Translated PCT Patent Application Publication (TOKUHYO) Nos. 2006-521278, 2010-535262, and 2010-540709. The contents of the above publications are expressly incorporated herein by reference in their entirety

Quantum dots containing cadmium are known. However, in recent years, from the perspective of reducing the environmental burden, the removal of cadmium from quantum dots has progressed. Cadmium-containing quantum dots (such as CdSe, CdTe, and CdS) normally have narrow half width of less than or equal to 50 nm while the light emission of cadmium-free quantum dots is normally a broad half width exceeding 50 nm. An aspect of the present invention makes it possible to expand the color reproducibility range without greatly decreasing brightness while using light emission based on quantum dots with broad half width in this manner. Accordingly, in a desirable embodiment, the fluorescent materials contained in the wavelength conversion member are cadmium-free (non-cadmium-containing) quantum dots.

In another embodiment, the fluorescent materials contained in the wavelength conversion member are ceramic fluorescent materials. The term “ceramic fluorescent material” refers not to a quantum dot, but to an inorganic fluorescent material. Examples are ceramic fluorescent materials in the form of inorganic crystals such as yttrium-aluminum-garnet (YAG), metal oxides, or metal sulfides to which metal elements are added as activating agents. Specific examples are the ceramic fluorescent materials given below. Below, the type of metal noted as cation following the “:” is a metal element that is added as an activating agent. Examples are: cerium-activated yttrium-aluminum-garnet (YAG:Ce³⁺) fluorescent material (YAG fluorescent material), (Ca, Sr, Ba)₂SiO₄:Eu²⁺, SrGa₂S₄:Eu²⁺, α-SiAlON:Eu²⁺, Ca₃Sc₂Si₃O₁₂: Ce³⁺, SrGa₂S₄:Eu²⁺, (Ca, Sr, Ba)S:Eu²⁺, (Ca, Sr, Ba)₂Si₅N₈:Eu²⁺, and CaAlSiN₃Eu²⁺. For example, in YAG fluorescent materials, part or all of the yttrium (Y) can be replaced with at least one element selected from the group consisting of Lu, Sc, La, Gd, and Sm, or part or all of the aluminum can be replaced with at least one or two from among Ga and In. In a YAG fluorescent material, the emission wavelength of the fluorescent material can be adjusted by changing the composition. For example, part or all of the Y in a YAG fluorescent material can be replaced with Gd to shift the emission wavelength to the longer wavelength side. Increasing the amount of Gd substituted can shift the emission wavelength to the long wavelength side. As a further example, replacing part of the Al in a YAG fluorescent material with Ga can shift the emission wavelength to the short wavelength side. That is, in this case, strongly bluish yellow (green) light can be used as a light-emitting fluorescent material. The composition of other ceramic fluorescent materials can also be adjusted to adjust the emission wavelength.

(ii) Method of Fabricating the Wavelength Conversion Member

The above-described fluorescent material is normally contained in a matrix in the wavelength conversion member. The matrix is normally a polymer (organic matrix) obtained by polymerizing a polymerizable composition by irradiation with light or the like. The shape of the wavelength conversion member is not specifically limited. For example, the wavelength conversion member is a member that comprises at least a fluorescent material-containing layer (wavelength conversion layer) and is in the form of a sheet or film optionally containing a barrier film or the like, described further below. The wavelength conversion layer is desirably fabricated by a coating method. Specifically, a polymerizable composition (curable composition) containing fluorescent material is coated on a suitable base material, after which a curing treatment is conducted by irradiation with light or the like to form a wavelength conversion layer.

The fluorescent materials can be added in the form of particles to the polymerizable composition (coating liquid) to form the wavelength conversion layer, or can be added in the form of dispersion in which they are dispersed in solvent. Addition in the form of dispersion is desirable from the perspective of inhibiting aggregation of particles of fluorescent material. The solvent employed is not specifically limited. About 0.01 weight part to 10 weight parts of the fluorescent material can be added per 100 weight parts of the total coating liquid, for example.

The polymerizable compound that is employed to prepare the polymerizable composition is not specifically limited. One type of polymerizable compound, or a mixture of two or more can be employed. The total quantity of the polymerizable composition accounted for by the total content of the polymerizable compound is desirably about 10% by weight to 99.99% by weight. From the perspectives of the transparence, adhesion, and the like of the cured coating film following curing, desirable examples of polymerizable compounds are monofunctional and multifunctional (meth)acrylate monomers, polymers thereof, prepolymers, and other monofunctional and multifunctional (meth)acrylate compounds. In the present invention and the description, the term “(meth)acrylate” means the use of either an acrylate or methacrylate, or both. The same applies to the term “(meth)acryloyl” and the like.

Examples of monofunctional (meth)acrylate monomers are acrylic acid, methacrylic acid, their derivatives, and more specifically, monomers having one polymerizable unsaturated bond of (meth)acrylic acid ((meth)acryloyl group) per molecule. For specific examples, reference can be made to paragraph 0022 in WO 2012/077807A1, which is expressly incorporated herein by reference in its entirety.

Multifunctional (meth)acrylate monomers having two or more (meth)acryloyl groups per molecule can be employed in combination with the above monomer having one polymerizable unsaturated bond ((meth)acryloyl group) of (meth)acrylic acid per molecule. For specific examples, reference can be made to paragraph 0024 in WO 2012/077807A1. The multifunctional (meth)acrylate compounds described in paragraphs 0023 to 0036 of Japanese Unexamined Patent Publication (KOKAI) No. 2013-043382, which is expressly incorporated herein by reference in its entirety, can be employed. The alkyl chain-comprising (meth)acrylate monomers denoted by general formulas (4) to (6) in paragraphs 0014 to 0017 in Japanese Patent No. 5129458, which is expressly incorporated herein by reference in its entirety, can also be employed.

From the perspective of coating strength, the quantity of the multifunctional (meth)acrylate monomer employed is desirably greater than or equal to 5 weight parts per 100 weight parts of the total quantity of the polymerizable compound contained in the polymerizable composition, and desirably less than or equal to 95 weight parts from the perspective of inhibiting gelling of the composition. From the same perspectives, the quantity of monofunctional (meth)acrylate monomer employed is desirably greater than or equal to 5 weight parts and less than or equal to 95 weight parts per 100 weight parts of the total quantity of the polymerizable compound contained in the polymerizable composition.

Desirable examples of polymerizable compounds are compounds having cyclic groups such as cyclic ether groups capable of undergoing ring-opening polymerization, such as epoxy groups and oxycetanyl groups. Preferred examples of such compounds are compounds having epoxy groups (epoxy compounds). Reference can be made to paragraphs 0029 to 0033 in Japanese Unexamined Patent Publication (KOKAI) No. 2011-159924, which is expressly incorporated herein by reference in its entirety, in regard to epoxy compounds.

The above polymerizable compound can contain a polymerization initiator in the form of a known radical polymerization initiator or cation polymerization initiator. For example, reference can be made to paragraph 0037 of Japanese Unexamined Patent Publication (KOKAI) No. 2013-043382, which is expressly incorporated herein by reference in its entirety, and paragraphs 0040 to 0042 of Japanese Unexamined Patent Publication (KOKAI) No. 2011-159924, which is expressly incorporated herein by reference in its entirety, for polymerization initiators. The polymerization initiator is desirably employed in a proportion of greater than or equal to 0.1 mol %, preferably 0.5 mol % to 5 mol %, of the total quantity of the polymerizable compound contained in the polymerizable composition.

The method of forming the wavelength conversion layer is not specifically limited so long as it is a layer containing the components set forth above and optionally added known additives. The components set forth above and one or more known additives added as needed can be simultaneously or sequentially mixed to prepare a composition that is coated on a suitable base material and then subjected to a polymerization treatment such as irradiation with light or heating to form a wavelength conversion layer containing fluorescent materials in a matrix. An example of a known additive is a silane coupling agent capable of enhancing adhesion to adjacent layers. Any known silane coupling agent can be employed without limitation. From the perspective of tight adhesion, examples of desirable silane coupling agents are the silane coupling agents denoted by general formula (1) in Japanese Unexamined Patent Publication (KOKAI) No. 2013-43382, which is expressly incorporated herein by reference in its entirety. Reference can be made to paragraphs 0011 to 0016 of Japanese Unexamined Patent Publication (KOKAI) No. 2013-43382 which is expressly incorporated herein by reference in its entirety, for details. The quantity of additives such as silane coupling agents that is employed is not specifically limited and can be suitably set. Solvent can be added as needed for the viscosity adjustment of the composition or the like. The type and quantity added of the solvent employed in such cases are not specifically limited. For example, solvent in the form of one or a mixture of two or more organic solvents can be employed.

The polymerizable composition can be coated on a suitable base material and then dried as needed to remove the solvent. Subsequently, it can be subjected to polymerization curing by irradiation with light or the like to obtain a wavelength conversion layer. Examples of the coating method include known coating methods such as curtain coating method, dip coating method, spin coating method, print coating method, spray coating method, slot coating method, roll coating method, slide coating method, blade coating method, gravure coating method, and wire bar method. The curing conditions can be appropriately set depending on the type of the polymerizable compound and the composition of the polymerizable composition.

The polymerization treatment of the above polymerizable composition can be conducted by any method. In one embodiment, it can be conducted with the polymerizable composition sandwiched between two base materials. One embodiment of a manufacturing process for a wavelength conversion member containing such a polymerization treatment will be described below with reference to the drawings. However, the present invention is not limited to the following embodiment.

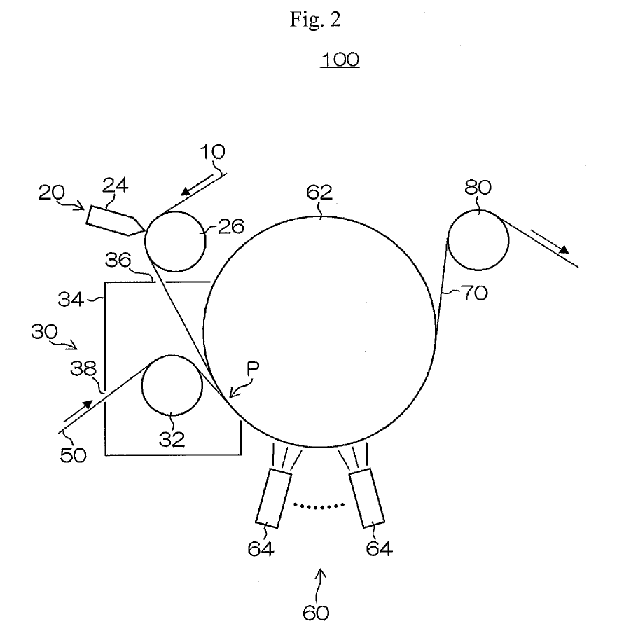

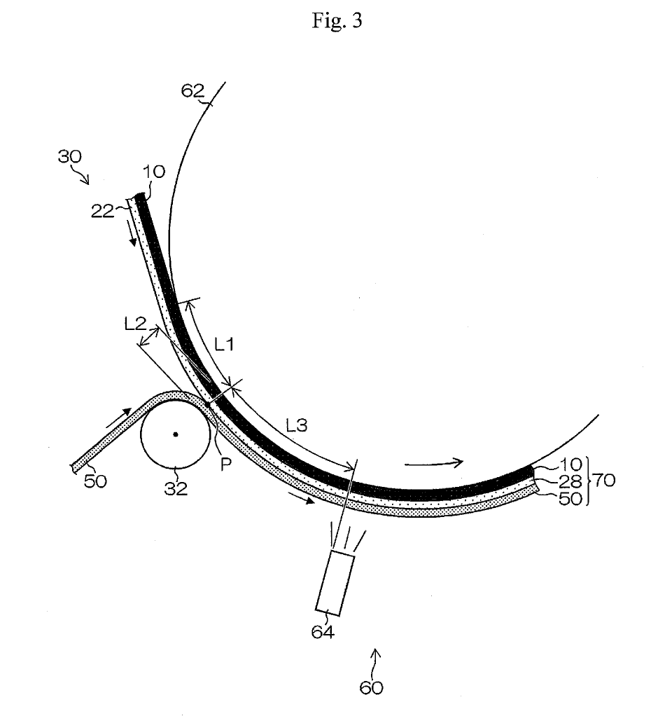

FIG. 2 shows a schematic configuration diagram of one example of a manufacturing apparatus 100 of the wavelength conversion member, and FIG. 3 shows a partially enlarged view of the manufacturing apparatus shown in FIG. 2. The production process of the wavelength conversion member by using the manufacturing apparatus 100 shown in FIGS. 2, 3 includes at least:

a step of forming a coating film by applying a polymerizable composition containing fluorescent materials on a surface of a first base material (hereinafter, also referred to as a “first film”) which is continuously conveyed,

a step of laminating (overlapping) on the coating film a second base material (hereinafter, also referred to as a “second film”) which is continuously conveyed to sandwich the coating film by the first film and the second film,

a step of taking up any one of the first film and the second film on a backup roller while maintaining the coating film sandwiched by the first film and the second film, and polymerizing and curing the coating film by irradiation of light while conveying the coating film continuously, to form a wavelength conversion layer (cured layer).

By using a barrier film having a barrier property against the oxygen and water as one of the first base material and the second base material, a wavelength conversion member which is protected on one side by the barrier film can be obtained. In addition, when using the barrier film as each of a first base material and the second base material, a wavelength conversion member where both sides of the wavelength conversion layer are protected by the barrier films can be obtained.

More specifically, first, a first film 10 is continuously conveyed from a feeding machine (not shown) to a coating portion 20. From the feeding machine, the first film 10 is fed out, for example, at a conveyance speed of 1 m/min to 50 m/min. However, the conveyance speed is not limited to the above speed. When being fed out, for example, a tension of 20 N/m to 150 N/m, preferably 30 N/m to 100 N/m is applied to the first film 10.

In the coating portion 20, the fluorescent material-containing polymerizable composition (hereinafter, also referred to as a “coating liquid”) is coated to the surface of the first film 10 to be continuously conveyed and thus a coating film 22 is formed (see FIG. 2). In the coating portion 20, for example, a die coater 24 and a backup roller 26 that is arranged opposite to the die coater 24 are provided. The surface of the first film 10 opposite to the surface on which the coating film 22 is formed is wound on the backup roller 26, and the coating liquid is applied from a discharge port of the die coater 24 to the surface of the first film 10 that is to be continuously conveyed and thus the coating film 22 is formed. Here, the coating film 22 is a coating liquid before polymerization treatment, which is coated on the first film 10,

In the present embodiment, the die coater 24 in which an extrusion coating method is used as a coating apparatus is illustrated, but the present invention is not limited thereto. For example, coating apparatuses in which various methods such as curtain coating method, extrusion coating method, rod coating method or role coating method are used can be used.

The first film 10 which passes through the coating portion 20 and on which the coating film 22 is formed is continuously conveyed to a laminating portion 30. In the laminating portion 30, a second film 50 which is continuously conveyed is laminated on the coating film 22 and thus the coating film 22 is sandwiched by the first film 10 and the second film 50.

In the laminating portion 30, a laminate roller 32 and a heating chamber 34 surrounding the laminate roller 32 are provided. The heating chamber 34 is provided with an opening 36 for the first film 10 to pass through and an opening 38 for the second film 50 to pass through.

A backup roller 62 is arranged at the position facing the laminate roller 32. The first film 10 on which the coating film 22 is formed is wound on the backup roller 62 at the surface opposite to the surface on which the coating film 22 is formed, and is continuously conveyed to a lamination position P. The lamination position P means a position where contact of the second film 50 with the coating film 22 starts. The first film 10 is preferably wound on the backup roller 62 before reaching the lamination position P. This is because, even if wrinkles are generated on the first film 10, the wrinkles can be corrected and removed by the backup roller 62 before the first film 10 reaches the lamination position P. Accordingly, a distance L1 from the point (contact position) where the first film 10 is wound on the backup roller 62 to the lamination position P is preferably long, for example, preferably 30 mm or more, and the upper limit is usually determined by a diameter of the backup roller 62 and a passing line.

According to the present embodiment, the lamination of the second film 50 is performed by the backup roller 62 used in a polymerization treatment portion 60 and the laminate roller 32. That is, the backup roller 62 used in the polymerization treatment portion 60 doubles as a roller in the laminating portion 30. However, the present invention is not limited to the above embodiment, and, a roller for lamination, which is not double as the backup roller 62, can be provided in the laminating portion 30 separately from the backup roller 62.

It is possible to reduce the number of rollers by using, in the laminating portion 30, the backup roller 62 used in the polymerization treatment portion 60. In addition, the backup roller 62 can also be used as a heat roller to the first film 10.

The second film 50 fed from the feeding machine which is not shown is wound on the laminate roller 32, and is continuously conveyed between the laminate roller 32 and the backup roller 62. The second film 50 is laminated on the coating film 22 formed on the first film 10 at the lamination position P. Thereby, the coating film 22 is sandwiched by the first film 10 and the second film 50. The term, laminate means stacking by overlapping the second film 50 on the coating film 22.

A distance L2 between the laminate roller 32 and the backup roller 62 is preferably a value of total thickness of the first film 10, the wavelength conversion layer (cured layer) 28 prepared by polymerizing and curing the coating film 22, and the second film 50, or more. L2 is preferably a length of total thickness of the first film 10, the coating film 22 and the second film 50 plus 5 mm, or shorter. When the distance L2 is the total thickness plus 5 mm or shorter, penetration of foam between the second film 50 and the coating film 22 can be prevented. The distance L2 between the laminate roller 32 and the backup roller 62 means the shortest distance from the outer peripheral surface of the laminate roller 32 and the outer peripheral surface of the backup roller 62.

A rotation accuracy of the laminate roller 32 and the backup roller 62 is equal to or less than 0.05 mm and, preferably equal to or less than 0.01 mm in a radian run-out. The smaller the radian run-out, the smaller the thickness distribution of the coating film 22 can be.

In order to inhibit the thermal deformation after sandwiching the coating film 22 by the first film 10 and the second film 50, a difference of a temperature of the backup roller 62 and a temperature of the first film 10 and a difference of a temperature of the backup roller 62 and a temperature of the second film 50 in the polymerization treatment portion 60 is preferably equal to or less than 30° C., more preferably equal to or less than 15° C., most preferably zero.

In order to make the difference from the temperature of the backup roller 62 smaller, when the heating chamber 34 is provided, it is preferable to heat the first film 10 and the second film 50 in the heating chamber 34. For example, a heated air can be supplied to the heating chamber 34 from a heated air generation device which is not shown to heat the first film 10 and the second film 50.

The first film 10 may be heated by the backup roller 62 by winding the first film 10 on the temperature-controlled backup roller 62.

On the other hand, with respect to the second film 50, by using the laminate roller 32 as a heating roller, the second film 50 can be heated by the laminate roller 32.

The heating chamber 34 and the heating roller are not essential, and may be provided as necessary.

Next, in a state where the coating film 22 is sandwiched by the first film 10 and the second film 50, the coating film 22 is continuously conveyed to the polymerization treatment portion 60. In the embodiment shown by the drawings, the polymerization treatment in the polymerization treatment portion 60 is performed by light irradiation, and in case where the polymerizable compound contained in the coating liquid is a compound which is polymerized by heating, the polymerization treatment can be performed by heating such as blowing of warm air.

The backup roller 62 and a light irradiation device 64 at the position facing the backup roller 62 are provided. The first film 10 and the second film 50 which sandwich the coating film 22 are continuously conveyed between the backup roller 62 and the light irradiation device 64. The light irradiated from the light irradiation device may be determined depending on the type of the photopolymerizable compound contained in the coating liquid, and one example includes an ultraviolet ray. Examples of a usable light source generating the ultraviolet ray include a low-pressure mercury lamp, a middle-pressure mercury lamp, a high-pressure mercury lamp, a super high-pressure mercury lamp, a carbon arc lamp, a metal halide lamp, a xenon lamp, and the like. Irradiation energy may be set within the range that can progress the polymerization and curing of the coating film, and for example, as one example, ultraviolet ray at irradiation energy of 100 mJ/cm² to 10000 mJ/cm² can be irradiated to the coating film 22.

In the polymerization treatment portion 60, the first film 10 is wound on the backup roller 62 in a state where the coating film 22 is sandwiched by the first film 10 and the second film 50, and while continuously conveyed, the coating film 22 can be cured by light irradiation from the light irradiation device 64, to form the wavelength conversion layer (cured layer) 28.

In the present embodiment, the side of the first film 10 is wound on the backup roller 62 and continuously conveyed, but it is also possible that the second film 50 is wound on the backup roller 62 and continuously conveyed.

“Being wound on the backup roller 62” means a state where one of the first film 10 and the second film 50 is in contact with the surface of the backup roller 62 at a certain wrap angle. Accordingly, during continuous conveyance, the first film 10 and the second film 50 moves in synchronization with the rotation of the backup roller 62. The winding on the backup roller 62 may be kept at least during the ultraviolet ray irradiation.

The backup roller 62 is provided with a column-shaped main body and axes of rotation arranged at the both edges of the main body. The main body of the backup roller 62 has a diameter φ of, for example, 200 mm to 1000 mm. The diameter φ of the backup roller 62 is not limited. In consideration of the curl deformation, cost for equipment, and rotation accuracy, the diameter is preferably φ 300 mm to 500 mm. The temperature of the backup roller 62 can be regulated by attaching a temperature regulator to the main body of the backup roller 62.

The temperature of the backup roller 62 can be determined in consideration of the heat generation at the time of light irradiation, the curing efficiency of the coating film 22, the generation of the wrinkle deformation of the first film 10 and the second film 50 on the backup roller 62. The temperature of the backup roller 62 is preferably set within the range of 10° C. to 95° C., more preferably 15° C. to 85° C. Here, the temperature relating to the roller means a surface temperature of the roller.

A distance L3 between the lamination position P and the light irradiation device 64 can be, for example, equal to or more than 30 mm.

As a result of light irradiation, the coating film 22 serves as the cured layer 28 to thereby produce a wavelength conversion member 70 including the first film 10, the cured layer 28 and the second film 50. The wavelength conversion member 70 is peeled off from the backup roller 62 by a peeling roller 80. The wavelength conversion member 70 is continuously conveyed to a take-up machine which is not shown in the drawing, and then the wavelength conversion member 70 is wound in a form of roll by the take-up machine.

An embodiment of a manufacturing process for the wavelength conversion member has been described above. However, the present invention is not limited to the above embodiment. For example, a polymerizable composition containing the fluorescent materials can be coated on a base material, and without laminating another base material thereover, a drying treatment can be conducted as needed and a polymerization treatment implemented to fabricate a wavelength conversion layer (cured layer). One or more other layers can be laminated by known methods on the wavelength conversion layer that has been fabricated. It is also possible to employ a base material in the form of the member that selectively reduces an amount of emitted light or a selective reflection member, the details of which are described further below.

The total thickness of the wavelength conversion layer desirably falls within a range of 1 μm to 500 μm, preferably within a range of 100 μm to 400 μm. The wavelength conversion layer can have a laminate structure in which fluorescent materials exhibiting differing light-emitting characteristics are contained in two or more different layers, or two or more fluorescent materials exhibiting different light-emitting characteristics can be contained in a single layer. When the wavelength conversion layer is a laminate of two or more layers, the thickness of each layer desirably falls within a range of 1 μm to 300 μm, preferably falls within a range of 10 μm to 250 μm, and more preferably, falls within a range of 30 μm to 150

<Layers that can be Included in the Wavelength Conversion Member, Base Material>

The above-described wavelength conversion member may be a structure consisting of the wavelength conversion layer or may be a structure having a base material described further below in addition to the wavelength conversion layer. Alternatively, at least one surface of the wavelength conversion layer can have at least one layer selected from the group consisting of an inorganic layer and an organic layer. Such an inorganic layer and an organic layer can include an inorganic layer and an organic layer constituting a barrier film mentioned below.

(Base Material)

The wavelength conversion member may have a base material for enhancement of strength, ease of film formation, and the like. The base material may be directly in contact with the wavelength conversion layer. The wavelength conversion member may include one or two or more of the base materials, and the wavelength conversion member may have a structure in which the base material, the wavelength conversion member and the base material are laminated in this order. When the wavelength conversion member has two or more base materials, the base materials may be the same or different. The base material is preferably transparent at visible light. Here, being transparent at the visible light means that a light transmittance in a visible light region is equal to or more than 80%, preferably equal to or more than 85%. The light transmittance used as an index of transparency can be calculated in accordance with the method described in JIS-K 7105, that is, by measuring a whole light transmittance and scattered luminous energy through the use of an integrated sphere-type light transmittance measuring device, and by subtracting a diffusion transmittance from the whole light transmittance.

The thickness of the base material is preferably within a range of 10 μm to 500 μm, more preferably within a range of 20 μm to 400 μm, further preferably within a range of 30 μm to 300 μm, from the viewpoint of gas barrier properties and impact resistance.

The base material may be used as either or each of the above-described first film and the second film.

The base material may be the barrier film. The barrier film is a film having a gas barrier function of blocking oxygen molecules. The barrier film may also preferably have a function of blocking moisture.

The barrier film may usually include at least an inorganic layer, and may be a film containing a supporting film and the inorganic layer. As to the supporting film, for example, paragraphs 0046 to 0052 of JP2007-290369A, paragraphs 0040 to 0055 of JP2005-096108A can be referred to. The contents of the above publications are expressly incorporated herein by reference in their entirety. The barrier film may be a film which includes a barrier laminate having at least one inorganic layer and at least one organic layer, on the supporting film. Examples are a laminated structure of supporting film/organic layer/inorganic layer, a laminated structure of supporting film/inorganic layer/organic layer, supporting film/organic layer/inorganic layer/organic layer (here, the two organic layers may be the same or different in terms of either or both of thickness and composition), and the like. Since the barrier property can be further increased by laminating a plurality of layers in this way, but the light transmittance of the wavelength conversion member is tend to be decreased along with the increase in the number of laminated layers, it is desirable that the number of the laminated layers is increased within the range in which good light transmittance can be maintained. Specifically, the barrier film preferably has an oxygen permeability of equal to or less than 1 cm³/(m²/day·atm). Here, the above-described oxygen permeability is a value measured by using an oxygen gas permeability measuring device (OX-TRAN 2/20 Trade name: manufactured by MOCON) under the conditions of a measurement temperature 23° C. and a relative humidity 90%. The barrier film preferably has a whole light transmittance over a visible light region of equal to or more than 80%. The visible light region means a region with a wavelength range of 380 nm to 780 nm, and the whole light transmittance shows a mean value of the light transmittances over the visible light region.

The oxygen permeability of the barrier film is more preferably equal to or less than 0.1 cm³/(m²·day·atm), further preferably equal to or less than 0 01 cm³/(m²·day·atm). The whole light transmittance in the visible light region is more preferably equal to or more than 90%. The lower the oxygen permeability is, the more preferable, and the higher the whole light transmittance in the visible light region is, the more preferable.

—Inorganic Layer—

The “inorganic layer” is a layer containing an inorganic material as a main component, and preferably is a layer formed only of an inorganic material. In contrast to this, the organic layer is a layer containing an organic material, and is a layer which contains an organic material in an amount of preferably equal to or more than 50% by weight, further preferably equal to or more than 80% by weight, and still further preferably equal to or more than 90% by weight.

The inorganic material constituting the inorganic layer is not particularly limited, and, for example, various inorganic compounds such as a metal, or an inorganic oxide, an inorganic nitride and an inorganic oxynitride can be used. Silicon, aluminum, magnesium, titanium, tin, indium and cerium are preferable as the element constituting the inorganic material, and one or two or more kinds thereof may be contained. Specific examples of the inorganic compound include silicon oxide, silicon oxynitride, aluminum oxide, magnesium oxide, titanium oxide, tin oxide, indium oxide alloy, silicon nitride, aluminum nitride, titanium nitride. In addition, a metal film such as aluminum film, silver film, tin film, chromium film, nickel film, titanium film may be provided as the inorganic layer.

Among the above-described materials, silicon nitride, silicon oxide, or silicon oxide nitride is particularly preferable. The reason is that since the inorganic layer formed of these materials has good adhesiveness to an organic layer, it is possible to further enhance the barrier property.

A method of forming the inorganic layer is not particularly limited, and various film forming methods that can accumulate a film forming material on a target surface for deposition by evaporating or scattering the material can be used, for example.

Examples of the method of forming the inorganic layer include a physical vapor deposition method such as a vacuum deposition method in which an inorganic material such as an inorganic oxide, an inorganic nitride, an inorganic oxynitride or metal is deposited by heating; an oxidation reaction deposition method in which an inorganic material is used as a raw material, and is oxidized by introducing an oxygen gas to thereby be deposited; a spattering method in which an inorganic material is used as a target material and is subjected to spattering by introducing an argon gas, an oxygen gas to thereby be deposited; or an ion-plating method in which an inorganic material is heated using a plasma beam generated by a plasma gun to thereby be deposited, and a plasma chemical vapor deposition method using an organic silicon compound as a raw material, and the like, in a film-forming of a deposition film of silicon oxide. The deposition may be carried out on a surface of a substrate such as a supporting film, a wavelength conversion layer or an organic layer.

The thickness of the inorganic layer is, for example, 1 nm to 500 nm, preferably 5 nm to 300 nm, and more preferably within a range of 10 nm to 150 nm. This is because, when the thickness of the inorganic layer is within the above-described range, reflection at the inorganic layer can be inhibited while achieving good barrier property, and thus a wavelength conversion member having a higher light transmittance can be provided.

In the wavelength conversion member, in an embodiment, at least one of the main surfaces of the wavelength conversion layer is preferably in direct contact with the inorganic layer. Each of the main surfaces of the wavelength conversion layer is also preferably in direct contact with the inorganic layer. In addition, in an embodiment, at least one of the main surfaces of the wavelength conversion layer is preferably in direct contact with the organic layer. Each of the main surfaces of the wavelength conversion layer is also preferably in direct contact with the organic layer. Here, the expression “main surface” means a surface (front surface, back surface) of the wavelength conversion layer which is arranged on the viewing side or the backlight side at the time of using the wavelength conversion member. The inorganic layer and the organic layer, two inorganic layers, or two organic layers may be stuck by using a known adhesive layer. From the viewpoint of enhancement of the light transmittance, the number of the adhesive layers is preferably small, and more preferably, no adhesive layer exists. In an embodiment, the inorganic layer is preferably in direct contact with the organic layer.

—Organic Layer—

With respect to the organic layer, paragraphs 0020 to 0042 of JP2007-290369A, paragraphs 0074 to 0105 of JP2005-096108A can be referred to. In an embodiment, the organic layer preferably contains a cardo polymer. This is because adhesion property to the layer adjacent to the organic layer, especially adhesion property to the inorganic layer becomes good, and thus more excellent gas barrier property can be achieved. Details of the cardo polymer can be referred to paragraphs 0085 to 0095 of JP2005-096108A. The thickness of the organic layer is preferably within a range of 0.05 μm to 10 μm, more preferably within a range of 0.5 μm to 10 μm. When the organic layer is formed by a wet coating method, the thickness of the organic layer is preferably within a range of 0.5 μm to 10 μm, more preferably within a range of 1 μm to 5 μm. When the organic layer is formed by a dry coating method, the thickness is preferably within a range of 0.05 μm to 5 μm, particularly preferably within a range of 0.05 μm to 1 μm. This is because, when the thickness of the organic layer formed by the wet coating method or the dry coating method is within the above range, the adhesion property to the inorganic layer can be made better.

In the present invention and the description, a polymer refers to a polymer obtained by polymerizing the same or different two or more compounds through polymerization reaction, and the expression “polymer” is used in a meaning including an oligomer, and the molecular weight is not particularly limited. In addition, the polymer may be a polymer having a polymerizable group and can be further polymerized by being subjected to a polymerization treatment such as heating or light irradiation, depending on kinds of polymerizable group.

In addition, the organic layer can be a cured layer formed by curing the polymerizable composition containing a (meth)acrylate polymer. The (meth)acrylate polymer is a polymer containing one or more (meth)acryloyl groups in one molecule. Examples of the (meth)acrylate polymer used for forming the organic layer can include is a (meth)acrylate polymer containing one or more urethane bonds in one molecule. Hereinafter, the (meth)acrylate polymer containing one or more urethane bonds in one molecule will be described as the urethane bond-containing (meth)acrylate polymer. When the barrier layer includes two or more organic layers, a cured layer formed by curing a polymerizable composition containing the urethane bond-containing (meth)acrylate polymer and other organic layer may be included. According to one aspect, the organic layer which is in direct contact with either or each of the main surfaces of the wavelength conversion layer is preferably the cured layer formed by curing a polymerizable composition containing the urethane bond-containing (meth)acrylate polymer.

In an embodiment of the urethane bond-containing (meth)acrylate polymer, a structural unit having an urethane bond is introduced to the side chain of the polymer. Hereinafter, a main chain to which the structural unit having a urethane bond is introduced will be described as the acryl main chain.

In addition, a (meth)acryloyl group is preferably contained at at least one terminal of the side chain having an urethane bond. More preferably, every side chain having an urethane bond contains (meth)acryloyl group. Further preferably, the (meth)acryloyl group contained at the terminal is an acryloyl group.

The urethane bond-containing (meth)acrylate polymer can be generally obtained by a graft-copolymerization, but is not particularly limited. The acryl main chain may be directly bonded to the structural unit having the urethane bond or may be bonded via a linkage group. Examples of the linkage group include ethylene oxide group, polyethylene oxide group, propylene oxide group, and polypropylene oxide group, and the like. The urethane bond-containing (meth)acrylate polymer may contain a plurality of kinds of side chain in which the structural units having urethane bond are bonded together via a different linkage group (including direct bond).

The urethane bond-containing (meth)acrylate polymer may have a side chain other than the structural unit having a urethane bond. An example of the other side chain is a linear or branched alkyl group. The linear or branched alkyl group is preferably a linear alkyl group with 1 to 6 carbon atoms, more preferably n-propyl group, ethyl group, or methyl group, and further preferably methyl group. In addition, the other side chain may contain other structure. This point also applies to the structural unit having a urethane bond.

The number of each of urethane bonds and (meth)acryloyl groups which are contained in one molecule of the urethane bond-containing (meth)acrylate polymer is one or more, preferably two or more, but is not particularly limited. The weight-average molecular weight of the urethane bond-containing (meth)acrylate polymer is preferably equal to or more than 10,000, more preferably equal to or more than 12,000, and further preferably equal to or more than 15,000. Furthermore, the weight-average molecular weight of the urethane bond-containing (meth)acrylate polymer is preferably equal to or less than 1,000,000, more preferably equal to or less than 500,000, and further preferably equal to or less than 300,000. The acryl equivalent of the urethane bond-containing (meth)acrylate polymer is preferably equal to or more than 500, more preferably equal to or more than 600, and further preferably equal to or more than 700; and the acryl equivalent is preferably equal to or less than 5,000, more preferably equal to or less than 3,000, and further preferably equal to or less than 2,000. The acryl equivalent is a value obtained by dividing the weight-average molecular weight by the number of the (meth)acryloyl groups per one molecule.

As the urethane bond-containing (meth)acrylate polymer, a polymer synthesized by a known method may be used, or a commercially available product may be used. Example of the commercially available product can include a UV (ultra violet) curable acryl-urethane polymer (8BR series) manufactured by TAISEI Fine Chemical Co., Ltd. The urethane bond-containing (meth)acrylate polymer is preferably contained in an amount of 5 to 90% by weight relative to total solid content 100% by weight of the polymerizable composition for forming an organic layer, more preferably 10 to 80% by weight.

In the curable compound for forming an organic layer, one or more of the urethane bond-containing (meth)acrylate polymer and one or more of other polymerizable compound may be used together. As the other polymerizable compound, a compound having an ethylenic unsaturated bond at the terminal or side chain is preferable. Examples of the compound having the ethylenic unsaturated bond at the terminal or side chain include a (meth)acrylate compound, an acrylamide-based compound, a styrene-based compound, maleic anhydride, and the like; preferably a (meth)acrylate compound, more preferably an acrylate compound.

As the (meth)acrylate compound, (meth)acrylate, polyester (meth)acrylate, epoxy (meth)acrylate, and the like are preferable. Examples of the (meth)acrylate compound can include the compounds described in paragraphs 0024 to 0036 of JP 2013-43382A, or paragraphs 0036 to 0048 of JP 2013-43384A. The contents of the above publications are expressly incorporated herein by reference in their entirety

Styrene, α-methylstyrene, 4-methylstyrene, divinylbenzene, 4-hydroxystyrene, 4-caroxystyrene, and the like are preferable as the styrene compound.

The polymerizable composition for forming an organic layer can also contain a known additive together with one or more polymerizable compounds. Example of such an additive can include an organic metal coupling agent. For details, the above description can be referred to. The organic metal coupling agent is preferably contained in an amount of 0.1 to 30% by weight, more preferably 1 to 20% by weight, provided that the total solid content of the polymerizable composition used for forming an organic layer is set as 100% by weight.

In addition, an example of the additive includes a polymerization initiator. When the polymerization initiator is used, the content of the polymerization initiator in the polymerizable composition is preferably equal to or more than 0.1 mole %, more preferably 0.5 to 5 mole % relative to the total amount of the polymerizable compounds. Examples of the polymerization initiator include Irgacure series manufactured by BASF (for example, Irgacure 651, Irgacure 754, Irgacure 184, Irgacure 2959, Irgacure 907, Irgacure 369, Irgacure 379, Irgacure 819, etc.), Darocure series (for example, Darocure TPO, Darocure 1173, etc.), Quantacure PDO, Ezacure series manufactured by Lamberti (for example, Ezacure TZM, Ezacure TZT, Ezacure KTO46, etc.), and the like.

The curing of the polymerizable composition for forming the organic layer can be performed by treatment (light irradiation, heating, and the like) appropriate to the type of the components (polymerizable compound, polymerization initiator) contained in the polymerizable composition. The curing conditions are not particularly limited, and can be set depending on the type of the components contained in the polymerizable composition and thickness of the organic layer, and the like.

For other details of the inorganic layer and the organic layer, the descriptions of JP 2007-290369A, JP2005-096108A, and further US 2012/0113672A1, which are expressly incorporated herein by reference in their entirety, can be referred to.

The inorganic layer and the organic layer, two organic layers, or two inorganic layers, may be stuck using an adhesive layer. From the viewpoint of enhancement of the light transmittance, the number of the adhesive layers is preferably small, and more preferably, there is no adhesive layer.

(Structural Members that can be Contained in the Light-Emitting Element)

At least the light source and wavelength conversion member set forth above are contained in the light-emitting element. The various structural members that are commonly contained in the light-emitting elements of backlight units can also be optionally incorporated. Examples of such structural members are light guide plates, reflective members (reflective plates), and diffusion members (diffusion sheets). The configuration of the backlight unit of an aspect of the present invention can be an edge light type with structural members in the form of a light guide plate, a reflective member (reflective plate), and the like, or can be a direct type. FIG. 1 shows an embodiment in the form of an example of an edge light type backlight unit. Known light-guide plates can be employed without limitation. Reflective members can be provided on the emission surface side and on the reflective side (rear) of the light guide plate. Such reflective members are not specifically limited and known reflective members can be employed. They are described in Japanese Patent Nos. 3416302, 3363565, 4091978, 3448626, and the like. The contents of the above publications are expressly incorporated herein by reference in their entirety.

<Member that Selectively Reduces an Amount of Emitted Light >

The member that selectively reduces an amount of emitted light, which is contained in the backlight unit along with the above-described light-emitting element, will be described in detail next.

The member that selectively reduces an amount of emitted light is positioned on the optical path of light exiting the light-emitting element. It has the capability of selectively reducing the amount of emitted light in the 680 nm to 730 nm wavelength range in the light that is emitted by the light-emitting element and enters the member that selectively reduces an amount of emitted light. More specifically, the term “amount of emitted light” is the amount of the light (emitted light) exiting to the emission side from the member that selectively reduces an amount of emitted light. Here, the “emission side” refers to the direction that becomes the liquid crystal panel side when the backlight unit of an aspect of the present invention is incorporated into a liquid crystal display device. Additionally, light that has been emitted by the light-emitting member enters from the opposite direction (entry side) from the emission side.

As set forth above, the above member having the capability of selectively reducing an amount of emitted light can selectively remove the light in the wavelength range to which the human eye has extremely low sensitivity from the light that is emitted by the backlight unit, thereby making it possible to expand the color reproducibility range without a large drop in brightness. In this context, the reason why the wavelength range over which the amount of emitted light is selectively reduced by the member that selectively reduces an amount of emitted light is made greater than or equal to 680 nm is that visual sensitivity in the long wavelength range of greater than or equal to 680 nm is extremely low. The reason why the wavelength range over which the amount of emitted light is selectively reduced by the member that selectively reduces an amount of emitted light is made less than or equal to 730 nm is that visual sensitivity in the wavelength range exceeding 730 nm is of a negligibly low level. When visual sensitivity is taken into account, it is desirable to selectively reduce an amount of emitted light in the wavelength range that is less than or equal to 780 nm in which only slight visual sensitivity exists. Since visual sensitivity does not exist in the wavelength range exceeding 780 nm, an amount of emitted light in the wavelength range exceeding 780 nm can be reduced or not reduced.

In this context, “selectively reducing an amount of emitted light” means that the reduction ratio of an amount of emitted light (amount of emitted light) to the amount of light entering the member that selectively reduces an amount of emitted light from the light-emitting element (the amount of entering light) (reduction ratio=((amount of entering light−amount of emitted light)/(amount of entering light))×100) is greater in the 680 nm to 730 nm wavelength range than in other wavelength ranges. The reduction ratio in other wavelength ranges is desirably as low as possible. For example, it is less than or equal to 20%, desirably less than or equal to 10%. When absorption loss and the like are taken into account, the reduction ratio in other wavelength ranges is, for example, greater than or equal to about 1%. By contrast, the reduction ratio in the 680 nm to 730 nm wavelength range is desirably greater than or equal to 50%, preferably greater than or equal to 70%, and more preferably, greater than or equal to 80%. The reduction ratio in the 680 nm to 730 nm wavelength range is less than or equal to 90%, for example. However, the higher the better. Thus, the upper limit is not specifically limited. The ratio of the intensity of wavelength 730 nm emitted light to the intensity in the emission center wavelength of red light in the light that is emitted from the member that selectively reduces an amount of emitted light (referred to as the “intensity ratio”, hereinafter) is desirably less than or equal to 10%, preferably less than or equal to 5%, and more preferably, less than or equal to 3%. The intensity ratio is, for example, greater than or equal to 1%, but the lower the better. Thus, the lower limit is not specifically limited.

In one embodiment, the member that selectively reduces an amount of emitted light has the capability of selectively absorbing light in the 680 nm to 730 nm wavelength range. In another embodiment, the member that selectively reduces an amount of emitted light has the capability of selectively reflecting light in the 680 nm to 730 nm wavelength range. Hereinafter, the former embodiment will be referred to as the absorptive member that selectively reduces an amount of emitted light and the latter embodiment will be referred to as the reflective member that selectively reduces an amount of emitted light. Each of these embodiments will be described in turn.

(Absorptive Member that Selectively Reduces an Amount of Emitted Light)

The absorptive member that selectively reduces an amount of emitted light can be imparted with the capability of selectively absorbing by incorporating a component having the property of absorbing light in the 680 nm to 730 nm wavelength range, for example. An example of such a component is a dye desirably having a capability of absorbing light in the 680 nm to 730 nm wavelength range. Examples of such dyes are various dyes known as near infrared-absorbing dyes. For example, phthalocyanine dyes, cyanine dyes, diimonium dyes, quaterylene dyes, dithiol Ni complex dyes, indoaniline dyes, azomethine complex dyes, aminoanthraquinone dyes, naphthalocyanine dyes, oxonol dyes, squarylium dies, and croconium dyes can be employed. Specific examples of these dyes are the various dyes described in Chemical Reviews, published in 1992, Vol. 92, No. 6, pp. 1197 to 1226; Absorption Spectra of Dyes for Diode Lasers, JOEM Handbook 2, Bunshin Shuppansha, published 1990; and The Development of Infrared-Absorbing Dyes for Use in Optical Disks, Fine Chemicals, Vol. 23, No. 3, published 1999. The contents of the above publications are expressly incorporated herein by reference in their entirety. Of these, the phthalocyanine dyes, diimonium dyes, and cyanine dyes are desirable. Further examples of desirable dyes are the dyes having absorption maximum wavelengths (desirably maximum absorption wavelengths) in the 680 nm to 730 nm wavelength range.

Examples of desirable phthalocyanine dyes are the phthalocyanine dyes denoted by general formula (I) below.

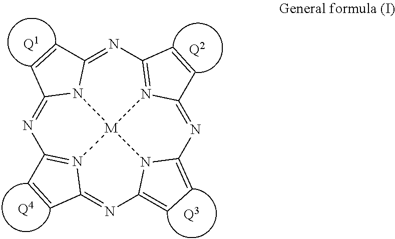

In general formula (I), each of Q¹ to Q⁴ independently denotes an aryl group or a heterocyclic group, with at least one denoting a nitrogen-containing heterocyclic group. M denotes a metal atom. Of Q¹ to Q⁴, it is desirable for two or three to be aryl groups and the remaining one or two to be nitrogen-containing heterocyclic groups.

The aryl groups can be single rings or fused rings. Single rings are desirable. Benzyl groups are particularly desirable as aryl groups.

The heterocyclic groups are desirably nitrogen-containing heterocyclic groups. The nitrogen-containing heterocyclic groups can contain hetero atoms in addition to nitrogen atoms. Examples of such hetero atoms are sulfur atoms. The nitrogen-containing heterocyclic groups desirably contain just hetero atoms in the form of nitrogen atoms. The nitrogen-containing heterocyclic groups are desirably five-membered or six-membered ring nitrogen-containing heterocyclic groups, preferably six-membered ring nitrogen-containing heterocyclic groups. The number of hetero atoms in the nitrogen-containing heterocyclic groups is desirably 1 to 5, preferably 2 to 4, and more preferably, 2 or 3.

The aryl groups and heterocyclic groups can comprise substituents. Reference can be made to paragraphs 0010 and 0011 in Japanese Unexamined Patent Publication (KOKAI) No. 2013-182028, which is expressly incorporated herein by reference in its entirety, for details regarding the substituents.

In the phthalocyanine dyes denoted by general formula (I), at least one among Q¹ to Q⁴ denotes a nitrogen-containing heterocyclic group and the others are desirably denoted by general formula (I-1) below.

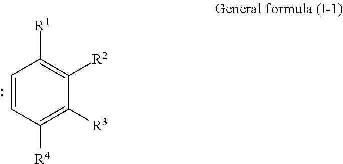

In formula (I-1), each of R¹, R², R³, and R⁴ independently denotes a hydrogen atom or a substituent, with a central skeleton being bonded at position “:”.

One or two from among R¹, R², R³, and R⁴ desirably denote substituents other than halogen atoms, with the remainder denoting hydrogen atoms or halogen atoms. It is preferable for one among them to be a substituent and for the remainder to be hydrogen atoms. Fluorine atoms are desirable as halogen atoms.

The weight of each of groups R¹, R², R³, and R⁴ (the molecular weight assuming that each group is a single molecule) is desirably 30 to 400, preferably 30 to 200.

In general formula (I), M denotes a metal atom, desirably Cu, Zn, Pb, Fe, Ni, Co, AlCl, AlI, InCl, InI, GaCl, GaI, TiCl₂, Ti═O, VCl₂, V═O, SnCl₂, or GeCl_{2;} preferably Cu, V═O, Mg, Zn, or Ti═O; and more preferably, Cu or V═O.

Phthalocyanine dyes can be synthesized by known methods. For example, they can be synthesized according to the description in Phthalocyanine Chemistry and Functions (IPC), which is expressly incorporated herein by reference in its entirety. Commercial products can also be employed. Phthalocyanine dyes are also available as commercial products.

Specific examples of phthalocyanine dyes denoted by formula (I) are given below. However, the present invention is not limited to these dyes. In the examples of compounds given below, those in which the center metal atom has been replaced with Cu, Zn, Pb, Fe, Ni, Co, AlCl, AlI, InCl, InI, GaCl, GaI, TiCl₂, Ti═O, VCl₂, V═O, SnCl₂, or GeCl₂ are desirably employed. In example compound A below, just one of the rings corresponding to Q¹ to Q⁴ in formula (I) is a nitrogen-containing ring. However, it is desirable for two or more of them to be nitrogen-containing rings. The same can apply to the other example compounds.

The example compounds given below can be synthesized by, for example, cyclizing two or more nitrile compounds. When synthesized in this manner, a mixture can be obtained. However, for the sake of convenience, only representative structures are given below. For example, example compound F below can be obtained by reacting nitrile compound a with nitrile compound b below in a mol ratio of 1:3. In terms of synthesis, this includes phthalocyanine dyes with structures where the ratio of the partial structure derived from nitrile compound a to the partial structure derived from nitrile compound b is from 0:4 to 4:0. Isomeric structures in which the disposition of functional groups differs are also included.

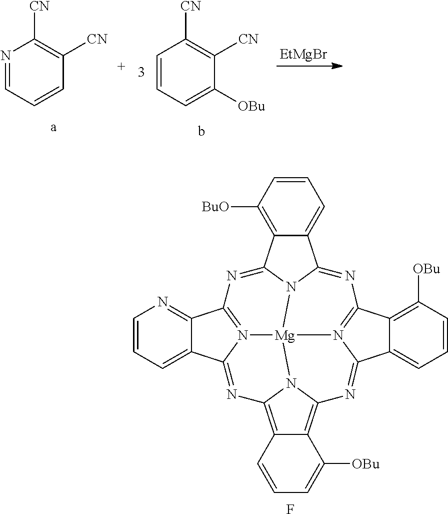

TABLE 1

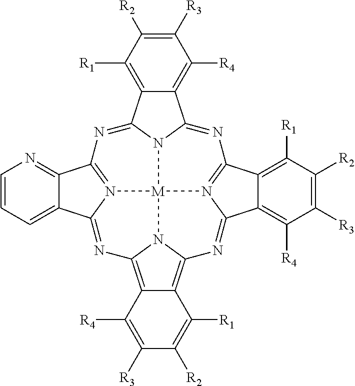

| | | | | | | Maximum |
|---|---|---|---|---|---|---|
| | | | | | | absorption |
| Compound | M | R¹ | R² | R³ | R⁴ | wavelength |
| A | Cu | OPh | H | H | H | 682 |
| B | Cu | OBu | H | H | H | 685 |
| C | Cu | SPh | H | H | H | 699 |
| D | Cu | 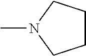 | H | H | H | 720 |
| E | VO | OBu | H | H | H | 697 |
| F | Mg | OBu | H | H | H | 683 |
| G | Zn | OBu | H | H | H | 682 |
| H | TiO | OBu | H | H | H | 688 |
| I | Cu | H | 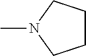 | H | H | 689 |
| J | Cu | OBu | H | H | OBu | 710 |
| K | Cu | F | F | 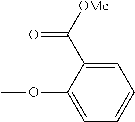 | F | 682 |

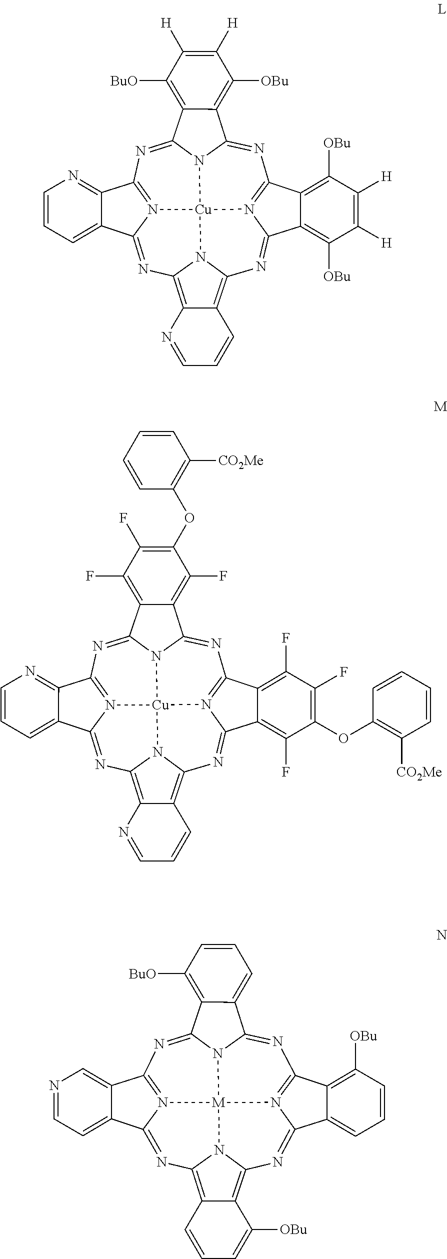

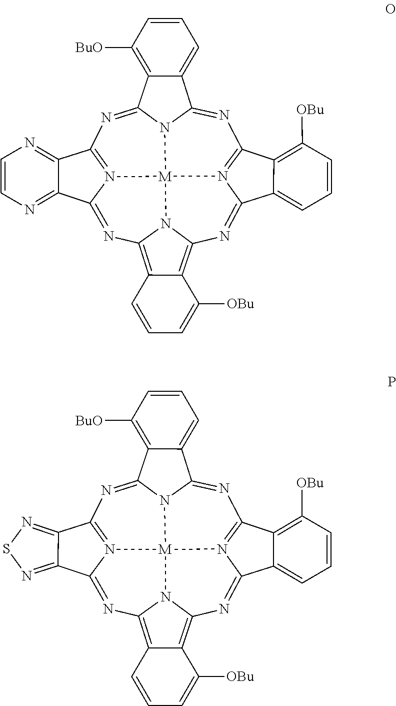

(In the above, M denotes a copper atom.)

A desirable example of a cyanine dye is the cyanine dye denoted by general formula (I) in Japanese Unexamined Patent Publication (KOKAI) No. 2009-108267, which is expressly incorporated herein by reference in its entirety. Reference can be made to paragraphs 0020 to 0051 in Japanese Unexamined Patent Publication (KOKAI) No. 2009-108267.

Examples of desirable diimonium dyes are the diimonium dyes denoted by general formula (II) in Japanese Unexamined Patent Publication (KOKAI) No. 2008-069260, which is expressly incorporated herein by reference in its entirety. Preferred examples of diimonium dyes are the diimonium dyes denoted by general formula (XII-1) in Japanese Unexamined Patent Publication (KOKAI) No. 2008-069260. Reference can be made to paragraphs 0072 to 0115 in Japanese Unexamined Patent Publication (KOKAI) No. 2008-069260 for details regarding the diimonium dyes denoted by these general formulas.

The absorptive member that selectively reduces an amount of emitted light can be formed, for example, by coating a polymerizable composition containing the above dye on a suitable base material and then conducting a curing treatment to obtain a member having an absorptive layer that selectively reduces an amount of emitted light. Reference can be made to the above description regarding the polymerizable composition that is employed to form the wavelength conversion layer, for example, with regard to details such as the components of the polymerizable compounds and the like that can be incorporated in such a polymerizable composition. Reference can also be made to paragraphs 0043 to 0200 in Japanese Unexamined Patent Publication (KOKAI) No. 2013-182028, paragraphs 0054 to 0063 of Japanese Unexamined Patent Publication (KOKAI) No. 2009-108267, and paragraphs 0117 to 0119 in Japanese Unexamined Patent Publication (KOKAI) No. 2008-69260. The contents of the above publications are expressly incorporated herein by reference in their entirety. Examples of the base material are the barrier films described above. The base material, such as a barrier film, that is employed as a base material for the wavelength conversion member can be also a base material for the member that selectively reduces an amount of emitted light. That is, the wavelength conversion member and the member that selectively reduces an amount of emitted light can be integrally laminated in the form of a member having a wavelength conversion layer on one side of a base material such as a barrier film and an absorptive layer that selectively reduces an amount of emitted light on the other side thereof. The same applies to the reflective member that selectively reduces an amount of emitted light described further below. The above dyes can be employed in a proportion of about 1 weight part to 30 weight parts per 100 weight parts of polymerizable compound in the polymerizable composition containing the above dyes, for example. However, since it suffices to be able to form a member that selectively reduces an amount of emitted light having the capability of selectively reducing the amount of light in the 680 nm to 730 nm wavelength range that is emitted to the emission side from the member that selectively reduces an amount of emitted light, the quantity of the above dye that is employed is not specifically limited.

(Reflective Member that Selectively Reduces an Amount of Emitted Light)

In one embodiment, an example of the reflective member that selectively reduces an amount of emitted light is a multilayered film obtained by laminating multiple layers of differing refractive index. The layers that constitute the multilayered film can be inorganic layers or organic layers. For example, a dielectric multilayered film obtained by successively laminating materials of differing refractive index (high refractive index materials and low refractive index materials) can be suitably employed. A metal/dielectric multilayered film in which a metal film has been added to the layer structure of a dielectric multilayered film can also be employed. This multilayered film can be formed by using a known film forming method such as electron beam (EB) vapor deposition (electron beam co-vapor deposition) or sputtering to deposit multiple film-forming materials on a base material. Multilayered film containing organic layers can be formed by known film-forming methods such as coating and laminating. A stretched film can be employed as the organic layer, for example.

An example of a dielectric multilayered film is one that comprises titanium dioxide (TiO₂) layers and silicon dioxide (SiO₂) layers deposited in alternating fashion. MgF₂, Al₂O₃, MgO, ZrO₂, Nb₂O₅, Ta₂O₅, and other dielectrics can also be employed as the dielectric. Reference can be made to the multilayered films described in Japanese Patent Nos. 3187821, 3704364, 4037835, 4091978, 3709402, 4860729, and 3448626 with regard to the structure of multilayered films. The contents of the above publications are expressly incorporated herein by reference in their entirety. Once the wavelength range that is to be reflected has been determined, the layer structure (the combination of film-forming materials and the thickness of the various layers) of a multilayered film that selectively reflects light in that wavelength range can be determined by known film design methods.

In one embodiment, an example of the reflective member that reduces an amount of emitted light is a light-reflecting layer in which a cholesteric liquid crystal phase is fixed. The wavelength range of the light that is reflected by the light-reflecting layer in which a cholesteric liquid crystal phase is fixed can be adjusted by changing the refractive index or the spiral pitch of the cholesteric liquid crystal phase. The spiral pitch of the cholesteric liquid crystal phase can be readily changed and adjusted by varying the quantity of chiral agent added. Specifically, reference can be made to the detailed description given in Fujifilm Research Report No. 50 (2005), pp. 60-63, which is expressly incorporated herein by reference in its entirety.

Suitable cholesteric liquid crystals can be employed to form the cholesteric liquid crystal phase; there is no specific limitation. The cholesteric liquid crystal phase, based on the spiral pitch, can selectively reflect just light of the center reflection wavelength λ (λ=nP, where n denotes the average refractive index of the liquid crystals and P denotes the spiral pitch) and the half width Δλ (Δλ=PΔn, where Δn denotes the anisotropy of the refractive index) centered on the center reflection wavelength X, and pass light of other wavelength ranges. Thus, it is practical for the anisotropy An of the refractive index of the liquid crystals employed in the light-reflecting layer in which a cholesteric liquid crystal phase is fixed to be about 0.06≦Δn≦0.5. This corresponds to a half width of 15 nm to 50 nm. Examples of materials for achieving such a An are the materials described in Japanese Translated PCT Patent Application Publication (TOKUHYO) No. 2011-510915, which is expressly incorporated herein by reference in its entirety, and the materials described in Japanese Unexamined Patent Publication (KOKAI) No. 2004-262884, which is expressly incorporated herein by reference in its entirety. When the cholesteric liquid crystal phase is controlled to a half width of less than or equal to 200 nm, it is possible to employ a method (the pitch gradient method) in which the pitch number in the spiral direction of the cholesteric liquid crystal phase gradually changes, without using a single pitch, making it possible to achieve a broad half width. Examples of the pitch gradient method are the method described in Nature 378, 467-46, 1995, which is expressly incorporated herein by reference in its entirety, and the method described in Japanese Patent No. 4990426, which is expressly incorporated herein by reference in its entirety.

—Cholesteric Liquid Crystal Compounds—

From the perspective of reducing film thickness and the like, the use of liquid crystal polymers as cholesteric liquid crystal compounds is advantageous. The greater the refractive index of the cholesteric liquid crystal compound, the broader the wavelength range that is selectively reflected, which is desirable.

Suitable liquid crystal polymers can be employed, such as main chain liquid crystal polymers such as polyesters; side chain liquid crystal polymers comprising acrylic main chains, methacrylic main chains, and siloxane main chains; nematic liquid crystal polymers containing a low-molecular-weight chiral agent; liquid crystal polymers in which chiral components are incorporated; and nematic and cholesteric mixed liquid crystal polymers. From the perspective of handling properties and the like, liquid crystal polymers with glass transition temperatures of 30° C. to 150° C. are desirable.

A cholesteric liquid crystal phase can be formed by the method of direct coating on a polarization separating plate over a suitable orientation film such as an oblique vapor deposition film of polyimide, polyvinyl alcohol, or SiO, as needed; the method of coating on a support, comprised of a transparent film or the like, that does not deteriorate at the orientation temperature of the liquid crystal polymer, over an orientation film as needed; or the like. A support with as small a phase differential as possible is desirably employed to prevent change in the polarization state. It is also possible to adopt the method of stacking cholesteric liquid crystal phases on an orientation film, or the like.

Coating of the liquid crystal polymer can be conducted by preparing a liquid product in the form of a solution in solvent, a melt obtained by heating, or the like, and employing a suitable spreading method such as a roll coating method, gravure printing method, or spin coating method.

The light-reflecting layer in which the cholesteric liquid crystal phase is fixed can be formed by coating a composition containing a polymerizable compound exhibiting a cholesteric liquid crystalline property (referred to hereinafter as a “polymerizable cholesteric liquid crystal compound”), forming a liquid crystal phase, and conducting polymerization curing to fix the liquid crystal phase. The use of a polymerizable cholesteric liquid crystal compound is desirable from the perspectives of coating suitability and reducing the thickness of the light-reflecting layer.

The term “polymerizable cholesteric liquid crystal compound” is a cholesteric liquid crystal compound having one or more polymerizable group per molecule. It can be a multifunctional compound having two or more polymerizable groups per molecule, or a monofunctional compound having one polymerizable group per molecule. The polymerizable group that is present in the polymerizable cholesteric liquid crystal compound need only by a group that is capable of undergoing a polymerization reaction, and is not specifically limited.

In one embodiment, the cholesteric liquid crystal compound is a rod-like liquid crystal compound.

Azomethines, azoxy compounds, cyanobiphenyls, cyanophenyl esters, benzoic acid esters, cyclohexane carboxylic acid phenyl esters, cyanophenylcyclohexanes, cyano-substituted phenyl pyrimidines, alkoxy-substituted phenyl pyrimidines, phenyl dioxanes, tolanes, and alkenyl cyclohexylbenzonitriles can be used as rod-like liquid crystal compounds.

By way of example, the compounds described in Makromol. Chem., Vol. 190, p. 2,255 (1989); Advanced Materials, Vol. 5, p. 107 (1993); U.S. Pat. Nos. 4,683,327, 5,622,648, and 5,770,107; WO 95/22586, 95/24455, 97/00600, 98/23580, and 98/52905; Japanese Unexamined Patent Publication (KOKAI) Heisei Nos. 1-272551, 6-16616, 7-110469, and 11-80081; and Japanese Unexamined Patent Publication (KOKAI) No. 2001-328973 can be employed as polymerizable rod-like liquid crystal compounds. The contents of the above publications are expressly incorporated herein by reference in their entirety.

By way of example, the compounds described in Japanese Translated PCT Patent Application Publication (TOKUHYO) Heisei No. 11-513019 and Japanese Unexamined Patent Publication (KOKAI) No. 2007-279688 are desirably employed as rod-like liquid crystal compounds. The contents of the above publications are expressly incorporated herein by reference in their entirety.

In one embodiment, the cholesteric liquid crystal compounds are disk-like liquid crystal compounds.

The disk-like liquid crystal compounds are not specifically limited. Desirable examples are the compounds described in Japanese Unexamined Patent Publication (KOKAI) Nos. 2007-108732 and 2010-244038. The contents of the above publications are expressly incorporated herein by reference in their entirety.

Desirable examples of disk-like liquid crystal compounds are given below. However, the present invention is not limited thereto.

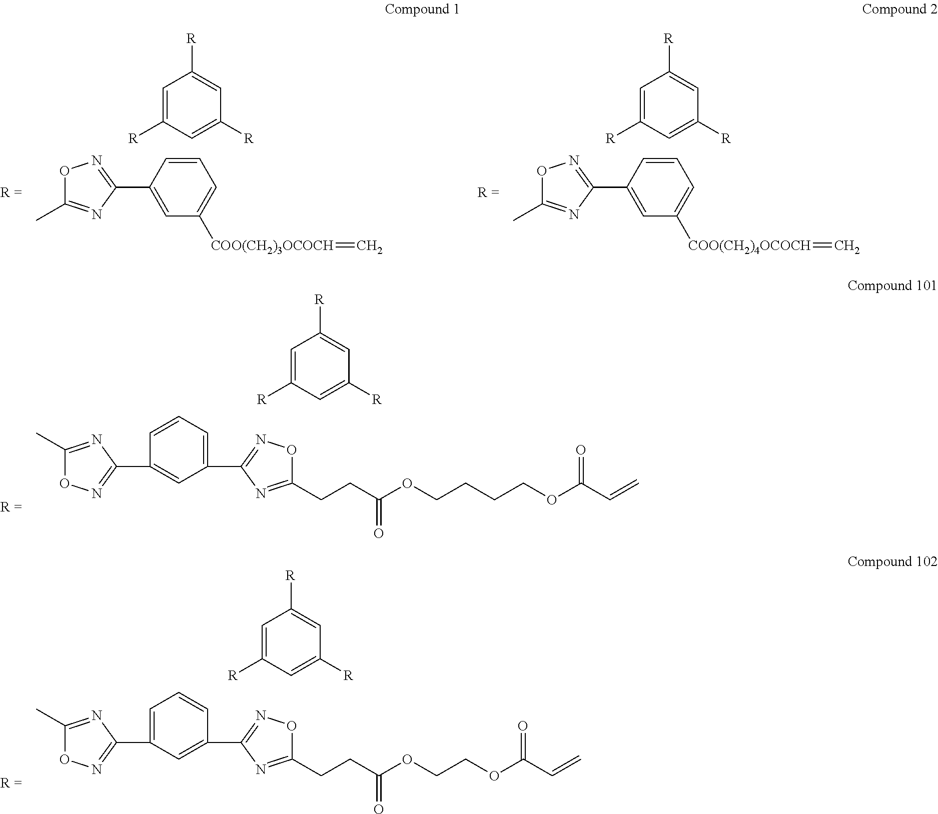

In one embodiment, the reflective member that selectively reduces an amount of emitted light having a light-reflecting layer in which a cholesteric liquid crystal phase is fixed comprises two or more layers selected from the group consisting of light-reflecting layers in which a cholesteric liquid crystal phase of a rod-like liquid crystal compound is fixed and light-reflecting layers in which a cholesteric liquid crystal phase of a disk-like liquid crystal compound is fixed. The reflective member that selectively reduces an amount of emitted light having two or more layers selected from the above group can contain two or more layers of just light-reflecting layers in which cholesteric liquid crystal phases of rod-like liquid crystal compounds are fixed, or can have two or more layers of just light-reflecting layers in which cholesteric liquid crystal phases of disk-like liquid crystal compounds are fixed. Alternatively, it can have one or more layers each of light-reflecting layers in which cholesteric liquid crystal phases of rod-like liquid crystal compounds are fixed and light-reflecting layers in which cholesteric liquid crystal phases of disk-like liquid crystal compounds are fixed, totaling two or more layers. In one embodiment, light-reflecting layers in which cholesteric liquid crystal phases of rod-like liquid crystal compounds are fixed and light-reflecting layers in which cholesteric liquid crystal phases of disk-like liquid crystal compounds are fixed are desirably laminated either directly or over one or more other layers in the reflective member that selectively reduces an amount of emitted light. The lamination of light-reflecting layers in which cholesteric liquid crystal phases of rod-like liquid crystal compounds are fixed and light-reflecting layers in which cholesteric liquid crystal phases of disk-like liquid crystal compounds are fixed in the reflective member that selectively reduces an amount of emitted light is desirable from the perspective of increasing the uniformity of color by decreasing the differential between the color experienced when observing the display surface of a liquid crystal display device into which has been built the backlight of an aspect of the present invention from directly in front and the color experienced when observing it in a diagonal direction. Here, the lamination sequence of the light-reflecting layers in which cholesteric liquid crystal phases of rod-like liquid crystal compounds are fixed and light-reflecting layers in which cholesteric liquid crystal phases of disk-like liquid crystal compounds are fixed is not specifically limited. Either can be disposed farther to the emission side.

—Other Components—

In addition to cholesteric liquid crystal compounds, the composition used to form the light-reflecting layer in which the cholesteric liquid crystal phase is fixed can contain other compounds such as chiral agents, orientation control agents, polymerization initiators, and orientation adjuvants.

Examples of orientation control agents are the compounds given by way of example in paragraphs 0092 and 0093 in Japanese Unexamined Patent Publication (KOKAI) No. 2005-99248, paragraphs 0076 to 0078 and 0082 to 0085 in Japanese Unexamined Patent Publication (KOKAI) No. 2002-129162, paragraphs 0094 and 0095 in Japanese Unexamined Patent Publication (KOKAI) No. 2005-99248, and paragraph 0096 in Japanese Unexamined Patent Publication (KOKAI) No. 2005-99248. The contents of the above publications are expressly incorporated herein by reference in their entirety.

Fluorine orientation control agents can also be used as orientation control agents. Desirable examples of fluorine orientation control agents are the compounds denoted by general formula (I) indicated in paragraph 0100 in Japanese Unexamined Patent Publication (KOKAI) No. 2013-203827, which is expressly incorporated herein by reference in its entirety. Reference can be made to paragraphs 0101 to 0108 in Japanese Unexamined Patent Publication (KOKAI) No. 2013-203827 for details regarding these compounds.

Examples of photopolymerization initiators are α-carbonyl compounds (described in U.S. Pat. Nos. 2,367,661 and 2,367,670); acyloin ethers (described in U.S. Pat. No. 2,448,828); α-hydrocarbon-substituted aromatic acyloin compounds (described in U.S. Pat. Nos. 3,046,127 and 2,951,758); combinations of triaryl imidazole dimers and p-aminophenyl ketones (described in U.S. Pat. No. 3,549,367); acridine and phenazine compounds (described in Japanese Unexamined Patent Publication (KOKAI) Showa No. 60-105667 and U.S. Pat. No. 4,239,850); oxadiazole compounds (described in U.S. Pat. No. 4,212,970); acylphosphineoxide compounds (described in Japanese Examined Patent Publication (KOKOKU) Showa No. 63-40799, Japanese Examined Patent Publication (KOKOKU) Heisei No. 5-29234, and Japanese Unexamined Patent Publication (KOKAI) Heisei Nos. 10-95788 and 10-29997). The contents of the above publications are expressly incorporated herein by reference in their entirety.

The methods described in Japanese Unexamined Patent Publication (KOKAI) Heisei No. 1-133003, Japanese Patent No. 3416302, Japanese Patent 3No. 3363565, and Japanese Unexamined Patent Publication (KOKAI) Heisei No. 8-271731 can be employed to fabricate the light-reflecting layer. The contents of the above publications are expressly incorporated herein by reference in their entirety.

In one embodiment, the selective reflection member, described further below, can be comprised of the same member as the member that reduces an amount of emitted light. For example, by stacking cholesteric liquid crystal phases, the same member can serve as the selective reflection member and the member that reduces an amount of emitted light as a light-reflecting layer. In the course of stacking such cholesteric liquid crystal phases, it is desirable to employ a combination that reflects circular polarization light in the same direction. In this manner, it is possible to align the phase states of the circular polarization light that is reflected by the various cholesteric liquid crystal phases, prevent different polarization states from occurring in the various wavelength ranges, and heighten light use efficiency. The light-reflecting layer in which the cholesteric liquid crystal phase is fixed can reflect at least either right circular polarization light or left circular polarization light in a wavelength range near its center reflection wavelength.

In the reflective member that selectively reduces an amount of emitted light, the multilayered film in which are laminated the multiple layers with different refractive indexes set forth above normally has the property of selectively reflecting one (either P polarization or S polarization) of the components of linear polarization light. In one embodiment, a reflective member that selectively reduces an amount of emitted light and has the property of reflecting any one of the components of linear polarization light is employed. In another embodiment, a multilayered film selectively reflecting the P polarization of linear polarization light and a multilayered film selectively reflecting the S polarization are stacked to fabricate a reflective member that selectively reduces an amount of emitted light. For example, multilayered films in the form of laminates of stretched films can be stacked so that the stretching directions of the first multilayered film and the second multilayered film are perpendicular, making it possible to reflect both the P polarization and S polarization components of linear polarization light.

The light-reflecting layer in which the cholesteric liquid crystal phase is fixed has the property of reflecting either right circular polarization light or left circular polarization light. Accordingly, by stacking a light-reflecting layer in which a cholesteric liquid crystal phase is fixed that selectively reflects right circular polarization light and a light-reflecting layer in which a cholesteric liquid crystal phase is fixed that selectively reflects left circular polarization light, it is possible to fabricate a reflective member that selectively reduces an amount of emitted light that is capable of reflecting both right circular polarization light and left circular polarization light. Such a reflective member that selectively reduces an amount of emitted light can be obtained, by example, by employing chiral agents with differing left/right optical rotation axes in the stacked light-reflecting layers.

Among brightness-enhancement plates (brightness-enhancement films), which are structural members that can be optionally incorporated into the backlight unit, there exist those having the function of reflective polarizers that reflect one component of linear polarization light or reflect either right circular polarization light or left circular polarization light. In a backlight unit that is equipped with such brightness-enhancement plates and a reflective member that selectively reduces an amount of emitted light, it is desirable to dispose the brightness-enhancement plate on the emission side where the reflective member that selectively reduces an amount of emitted light emits light. It is preferable to dispose a brightness-enhancement plate that reflects polarization light (for example, either P polarization or S polarization in the case of linear polarization light, and right circular polarization or left circular polarization in the case of circular polarization light) differing from the reflective member that selectively reduces an amount of emitted light. Thus, even when the reflective member that selectively reduces emitted light reflects just one type of polarization light, the polarization light that passes through the reflective member that selectively reduces an amount of emitted light without being reflected will be reflected by the brightness-enhancement plate. Examples of such brightness-enhancement plates are the brightness-enhancement plates of polymer multilayered reflective films described in U.S. Pat. Nos. 5,808,794 and 7,791,687, and Japanese Unexamined Patent Publication (KOKAI) No. 2012-237853. A specific example of a commercial product is the DBEF (Japanese registered trademark) series made by Sumitomo 3M Ltd. Further examples are the brightness-enhancement plates employing cholesteric liquid crystal layers described in Japanese Unexamined Patent Publication (KOKAI) Heisei Nos. 6-281814 and 11-122412 and in Japanese Unexamined Patent Publication (KOKAI) No. 2004-264322. Specific examples of commercial products are NIPOCS (Japanese registered trademark) made by Nitto Denko Corporation. These can have a broad brightness-enhancement range in the visible light range, or can utilize a brightness-enhancement range in just a necessary wavelength range. Those having a selective brightness-enhancement range in just the specific wavelength range of blue light, or the specific wavelength ranges of green light and blue light are desirable because they permit the selective brightness enhancement of just the wavelength ranges that contribute to expanding the color reproducibility range, and thus further effectively expand the color reproducibility range. Providing a brightness-enhancement plate is desirable in that it permits the reflection of various types of polarization light while not requiring the above stacking or reducing the number of stacked laminations, and from the perspective of simplifying the process of fabricating the member that selectively reduces an amount of emitted light. Providing a brightness-enhancing plate can reduce the light loss in the liquid crystal panel, and is thus desirable from the perspective of providing a liquid crystal display device of heightened brightness.

The above-described absorptive member that selectively reduces an amount of emitted light and reflective member that selectively reduces an amount of emitted light can be formed on suitable base materials. Such base materials are not specifically limited. Examples are the barrier film set forth above. Using a barrier film containing a member that reduces an amount of emitted light to fabricate a wavelength conversion member permits the integrated lamination of the member that reduces an amount of emitted light and the wavelength conversion member. More specifically, by way of example, the member that selectively reduces an amount of emitted light can be formed on one surface of a barrier film, and the wavelength conversion layer can be formed on the other surface to integrate lamination of the member that selectively reduces an amount of emitted light and the wavelength conversion member. It is also possible to form the member that selectively reduces an amount of emitted light on the base material in the form of a structural member of the backlight unit such as a prism sheet, diffusion sheet, or brightness-enhancement plate contained separately from the wavelength conversion member.

The shape of the member that selectively reduces an amount of emitted light is not specifically limited. For example, it can be in the form of a sheet or a film. In an embodiment in which the member that selectively reduces an amount of emitted light is provided in the form of a sheet or film, such as a layer that selectively reduces an amount of emitted light, the thickness of the layer that selectively reduces an amount of emitted light is, for example, 0.1 μm to 100 μm, desirably 0.5 μm to 5 μm. It is also possible to provide a layer that selectively reduces an amount of emitted light and a wavelength conversion layer as adjacent layers in direct contact. Lamination through other layers such as a base materials is also possible. In an absorptive layer that selectively reduces an amount of emitted light, it is desirable to laminate the above two layers through another layer such as a base material. More specifically, this is done as follows. An absorptive layer that selectively reduces an amount of emitted light can be thought of as taking on heat by absorbing light of 680 nm to 730 nm wavelength. Accordingly, particularly in a wavelength conversion layer containing fluorescent materials that undergo a drop in emission efficiency due to heat, laminating an absorptive member that selective reduces an amount of emitted light through another layer is desirable to control the rise in temperature. For example, quantum dots are said to tend to decrease in emission efficiency (quantum efficiency) due to heat. Thus, in one embodiment, a wavelength conversion layer containing quantum dots is desirably disposed with an absorptive layer that selectively reduces an amount of emitted light through another layer. However, positioning the absorptive layer that selectively reduces an amount of emitted light and the wavelength conversion layer as adjacent layers in direct contact is also possible. For example, a wavelength conversion layer containing fluorescent materials with good heat resistance and an absorptive layer that selectively reduces an amount of emitted light can be disposed as adjacent layers in direct contact.

In an embodiment in which a reflective member that selectively reduces an amount of emitted light is provided in a backlight unit, it is also desirable to provide a selective absorption member having the capability of selectively absorbing light in the 680 nm to 730 nm wavelength range. It is possible to employ such a selective absorption member in the form of one that can be used as an absorptive member that selectively reduces an amount of emitted light. Causing light in the 680 nm to 730 wavelength range that has been reflected by a reflective member that selectively reduces an amount of emitted light to be absorbed by a selective absorption member can prevent this light from being diffusely reflected in the light-guide plate of the light-emitting element, for example, and causing the brightness to drop. Such a selective absorption member can be positioned, for example, on a light-guide plate between the light source and the wavelength conversion member. The selective absorption member is desirably positioned as a member that is separated from the wavelength conversion member. Positioning it as a separated member is desirable from the perspective of inhibiting the rise in temperature set forth above. In this context, the term “separated” means that they are not integrality laminated, and desirably means that a layer of air is present between the two members.

<Selective Reflection Member>

In addition to the member that selectively reduces an amount of emitted light, the backlight unit of an aspect of the present invention can further comprise a selective reflection member having a reflective peak in at least the wavelength range of either:

a wavelength range between the emission center wavelength of blue light and the emission center wavelength of green light (reflection wavelength range 1); and

a wavelength range between the emission center wavelength of green light and the emission center wavelength of red light (reflection wavelength range 2).

As set forth above, such a selective reflection member makes it possible to reduce an amount of emitted light from the backlight unit in the light of the above wavelength range that is contained in the light emitted by the light-emitting element. Providing such a selective reflection member is desirable from the perspective of further expanding the color reproducibility range by narrowing the half width of the light of various colors. Further, the light reflected by the selective reflection member and entering the wavelength conversion member can become exciting light. The fluorescent materials in the wavelength conversion member can be excited and new fluorescence can be emitted, thereby preventing a large drop in brightness due to a drop in an amount of emitted light from the backlight unit in the form of light in the wavelength range that has been reflected. Thus, it is possible to further expand the color reproducibility range without inviting a large drop in brightness. Thus, fluorescent materials that are excited by either, or both, light of reflection wavelength range 1 and reflection wavelength range 2 are desirably employed. Generally, green fluorescent material and red fluorescent material can be excited with light in reflection wavelength range 1 or light in reflection wavelength range 2.

From the perspective of expanding the color reproducibility range, reflection wavelength range 1 is desirably a range of 490 nm to 510 nm, preferably a range of 480 nm to 520 nm. From the same perspective, reflection wavelength range 2 is desirably a range of 570 mu to 590 nm, preferably a range of 560 nm to 600 nm.

The method of fabricating the selective reflection member is not specifically limited. For example, by adopting the means for selectively adjusting the wavelength range that is reflected in the structure described for a reflective member that selectively reduces an amount of emitted light, a selective reflection member can be obtained that has a reflection peak in reflection wavelength range 1 or 2, or has reflection peaks in both reflection wavelength range 1 and reflection wavelength range 2. The member that selectively reduces an amount of emitted light and the selective reflection member can be a single member. Such members include, by way of example: a member in which the layer that selectively reduces an amount of emitted light and the selective reflection layer are laminated through another layer, such as a base material, or as adjacent layers; a member that exhibits a reflecting property for the light of one or both of reflection wavelength range 1 and reflection wavelength range 2, as well as a reflecting property or an absorbing property for light in the wavelength range of 680 nm to 730 nm in a single layer; and the like.

When a selective reflection member employing a cholesteric liquid crystal phase is provided so that it has a reflection peak for one or both of reflection wavelength range 1 and reflection wavelength range 2, the half width AX of the reflection range desirably falls within a range of 50 nm to 15 nm, preferably within a range of 40 nm to 20 nm. Within the above range, it is possible to suitably achieve both enhanced color reproducibility on the display and enhanced brightness on the display. In this case, the anisotropy An of the refractive index of the liquid crystal compound employed desirably falls within a range of 0.06 to 0.25, preferably within a range of 0.08 to 0.18. The above range is desirable because it makes it possible to achieve a selective reflection member that exhibits a suitable half width while exhibiting stable liquid crystal properties.

When the half width Δλ is small, a phenomenon whereby the reflection peak wavelength of the selective reflection member shifts with the angle of the light entering the selective reflection member will sometimes be seen. In one embodiment, when such a phenomenon is observed, it is possible to provide a layer (compensation layer) that compensates for the shift in the reflection peak wavelength. Such a compensation layer can be achieved, for example, by suitably setting the retardation Rth in the direction of thickness for the liquid crystal compound employed.

The shape of the selective reflection member is not specifically limited. For example, it can be in the form of a sheet or film. In an embodiment in which a selective reflection layer is provided as a selective reflective member in the form of a sheet or a film, for example, the thickness of the selective reflection layer is, for example, 0.1 μm to 100 μm, desirably 1 μm to 5 μm.

The order of arrangement of the selective reflection member and the member that selectively reduces an amount of emitted light is such that either can be present on the emission side of the backlight unit. The selective reflection member and the member that selectively reduces an amount of emitted light can be separate members or a single member. Further, the selective reflection member and the wavelength conversion member can also be a single member. The two members of the selective reflection member and the member that selectively reduces an amount of emitted light can also be a single member with the wavelength conversion member.

In addition to the structural members set forth above, the backlight unit of an aspect of the present invention is desirably equipped with a known diffusion plate or sheet, prism sheet (such as the BEF series made by Sumitomo 3M Ltd.), or the like. These other members are described in Japanese Patent Nos. 3416302, 3363565, 4091978, and 3448626, which are expressly incorporated herein by reference in their entirety.

### Liquid Crystal Display Device

The liquid crystal display device according to an aspect of the present invention includes at least the above backlight unit and a liquid crystal cell.

(Configuration of Liquid Crystal Display Device)

The driving mode of the liquid crystal cell is not particularly limited, and various modes such as twisted nematic (TN), super twisted nematic (STN), vertical alignment (VA), in-play-switching (IPS), and optically compensated bend cell (OCB) can be utilized. The liquid crystal cell is preferably VA mode, OCB mode, IPS mode or TN mode, but is not particularly limited thereto. One example of the configuration of the liquid crystal cell of VA mode is the configuration shown in FIG. 2 of JP 2008-262161 A, which is expressly incorporated herein by reference in its entirety. However, the specific configuration of the liquid crystal display device is not particularly limited, and a known configuration can be adopted.

One embodiment of the liquid crystal display device has a configuration in which the device includes a liquid crystal cell having a liquid crystal layer sandwiched between two opposing substrates at least one of which is provided with an electrode, and in which the liquid crystal cell is arranged between two polarizing plates. The liquid crystal display device has a liquid crystal cell where a liquid crystal is sealed between the upper and lower substrates and displays an image by changing a state of orientation of the liquid crystal through applying a voltage. Furthermore, as necessary, the device includes additional functional layers such as a polarizing plate protective film, an optically compensatory member which can perform optical compensation, and an adhesive layer. In addition, there may be arranged a color filter (color filter substrate), a thin layered transistor substrate, a lens film, a diffusion sheet, a hard coating layer, an antireflective layer, a low reflective layer, an antiglare layer, etc. and together (or instead thereof), a surface layer such as a forward scattering layer, a primer layer, an antistatic layer, or an under coating layer.

In the backlight unit of an aspect of the present invention, white light can be achieved by using blue light, green light, and red light having emission center wavelengths in the wavelength ranges selected by color filters. This is desirable from the perspective of enhancing brightness, as set forth above.

The desirable characteristics of the color filters are described in Japanese Unexamined Patent Publication (KOKAI) No. 2008-083611, which is expressly incorporated herein by reference in its entirety, and the like.

For example, one of the wavelengths where half the transmittance of the maximum transmittance is reached in the color filter exhibiting green is desirably greater than or equal to 590 nm and less than or equal to 610 nm. The other is desirably greater than or equal to 470 nm and less than or equal to 500 nm Further, one of the wavelengths where half the transmittance of the maximum transmittance is reached in the color filter exhibiting green is preferably greater than or equal to 590 nm and less than or equal to 600 nm. The maximum transmittance in the color filter exhibiting green is desirably greater than or equal to 80%. The wavelength where the maximum transmittance is reached in a color filter exhibiting green is desirably greater than or equal to 530 nm and less than or equal to 560 nm.

In a color filter exhibiting green, the transmittance at the peak emission wavelength is desirably less than or equal to 10% of the maximum transmittance.

In a color filter exhibiting red, the transmittance at greater than or equal to 580 nm and less than or equal to 590 nm is desirably less than or equal to 10% of the maximum transmittance.

Known color filter pigments can be employed without limitation. Currently, pigments are generally employed. However, color filters based on dyes can be employed if the dyes permit spectral control, afford stable processing, and ensure reliability.

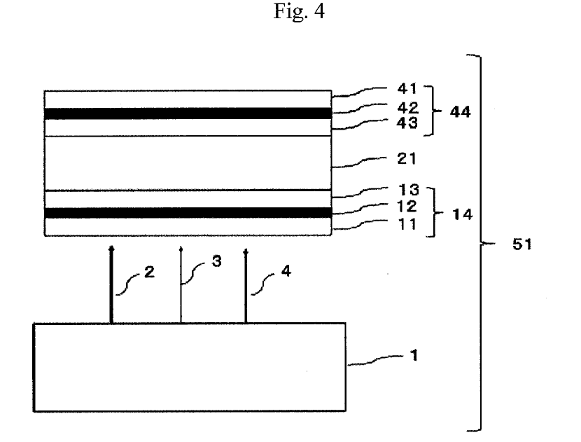

FIG. 4 shows one example of the liquid crystal display device according to an aspect of the present invention. The liquid crystal display device 51 shown in FIG. 4 has a backlight-side polarizing plate 14 on the surface of the backlight-side of the liquid crystal cell 21. The backlight side polarizing plate 14 may or may not include a polarizing plate protective film 11 on the surface of the backlight side of a backlight side polarizer 12, and preferably may include the protective film 11.

The backlight side polarizing plate 14 preferably has a configuration in which the polarizer 12 is sandwiched by the two polarizing plate protective films 11 and 13.

In the description, a polarizing plate protective film close to the liquid crystal cell with respect to the polarizer is referred to as an inner-side polarizing plate protective film, and a polarizing plate protective film apart from the liquid crystal cell with respect to the polarizer is referred to as an outer-side polarizing plate protective film. In the example shown in FIG. 4, the polarizing plate protective film 13 is the inner-side polarizing plate protective film, and the polarizing plate protective film 11 is the outer-side polarizing plate protective film

The backlight-side polarizing plate may have a retardation film as an inner-side polarizing plate protective film on the liquid crystal cell side. A known cellulose acrylate film can be used as such a retardation film.

The liquid crystal display device 51 has a display-side polarizing plate 44 on the surface opposite to the surface of the backlight side of the liquid crystal cell 21. The display-side polarizing plate 44 has a configuration in which a polarizer 42 is sandwiched by two polarizing plate protective films 41 and 43. The polarizing plate protective film 43 is the inner-side polarizing plate protective film, and the polarizing plate protective film 41 is the outer-side polarizing plate protective film.

The backlight unit 1 that the liquid crystal display device 51 has is as described above.

The liquid crystal cell, the polarizing plate, the polarizing plate protective film, and the like constituting the liquid crystal display device according to an aspect of the present invention are not particularly limited, and it is possible to use any one produced by a known method and a commercially available product without any limitation. In addition, a known medium layer such as an adhesive layer can be provided between the layers.

### EXAMPLES

The present invention will be more specifically explained on the basis of Examples below. The material, amount used, proportion, treatments, treating procedure, and the like shown in the following Examples can be appropriately modified as long as the modifications thereof do not depart from the gist of the present invention. Accordingly, the scope of the present invention should not be interpreted limitedly by the following Examples.

The absorption peak wavelength (maximum absorption wavelength) and reflection peak wavelength (maximum reflection wavelength) of the various materials indicated below are values measured by the following methods.

The light transmittance at wavelengths of 380 nm to 780 nm was measured at a relative humidity of 60% and a temperature of 25° C. with a spectrophotometer (UV-3150, made by Shimadzu Corporation). For the member that selectively reduces an amount of emitted light, the minimum wavelength in the 680 nm to 780 nm of the light transmittance spectrum measured was adopted as the the peak absorption wavelength (maximum absorption wavelength), peak reflection peak wavelength (maximum reflection wavelength). For the selective reflection member, the minimum wavelength in the wavelength range (reflection wavelength range 1) between the emission center wavelength of blue and the emission center wavelength of green and in the wavelength range (reflection wavelength range 2) between the emission center wavelength of green and the emission center wavelength of red in the light transmittance spectra that were measured were adopted as the reflection peak wavelengths (maximum reflection wavelengths).

1. Fabrication of Barrier Film 10

An organic layer and an inorganic layer were sequentially formed on one surface of a polyethylene terephthalate film (PET film, made by Toyobo, product name: Cosmoshine (Japanese registered trademark) A4300, 50 μm in thickness).

Trimethylolpropane triacrylate (TMPTA made by Daicel Cytec, Inc.) and polymerization initiator (ESACURE KTO46, made by Lamberti, Inc.) were prepared and weighed out in a weight ratio of former:latter=95:5. These were dissolved in methyl ethyl ketone to obtain a coating liquid with a solid fraction concentration of 15%. The coating liquid was roll-to-roll coated on the above PET film with a die coater and passed for 3 minutes through a 50° C. drying zone. Subsequently, ultraviolet radiation was radiated (cumulative dose of about 600 mJ/cm²) in a nitrogen atmosphere to induce UV curing. The product was wound. The thickness of the first organic layer formed on the support was 1 μm.

An inorganic layer (silicon nitride layer) was formed on the surface of the first organic layer with a roll-to-roll chemical vapor deposition (CVD) device. Silane gas (flow rate 160 sccm), ammonia gas (flow rate 370 sccm), hydrogen gas (flow rate 590 sccm), and nitrogen gas (flow rate 240 sccm) were employed as the starting material gases. A high-frequency power source with a frequency of 13.56 MHz was employed as the power source. The film-forming pressure was 40 Pa and the film thickness achieved was 50 nm. In this manner, an inorganic layer was laminated onto the surface of the first organic layer to fabricate barrier film 10.

2. Preparation of Fluorescent Material-Containing Polymerizable Composition (Fluorescent Material Dispersion) for Forming Wavelength Conversion Layer

### Preparation Example 1

The following fluorescent material dispersion A was prepared as a fluorescent material-containing polymerizable composition for forming a wavelength conversion layer, passed through a filter made of polypropylene with a 0.2 μm pore diameter, and dried at reduced pressure for 30 minutes to obtain a coating liquid. The quantum dot concentration in the toluene dispersion below was 1% by weight.

### Fluorescent Material Dispersion A

| | |
|---|---|
| Toluene dispersion of quantum dot 1 | 10.0 weight parts |
| (emission maximum: 530 nm) | |
| Toluene dispersion of quantum dot 2 | 1.0 weight part |
| (emission maximum: 620 nm) | |
| Lauryl methacrylate | 99.0 weight parts |
| Photo-radical polymerization initiator | 1.0 weight part |
| (Irgacure (Japanese registered trademark) 819 | |
| (made by BASF)) | |

The following nanocrystals having a core-shell structure (InP/ZnS) were employed as quantum dots 1 and 2.

Quantum dot 1: INP530-10 (made by NN-labs): Fluorescent half width 65 nm

Quantum dot 2: INP620-10 (made by NN-labs): Fluorescent half width 70 nm

The viscosity of fluorescent material dispersion A was 50 mPa·s.

### Preparation Example 2

The following fluorescent material dispersion B was prepared as a fluorescent material-containing polymerizable composition for forming a wavelength conversion layer, uniformly dispersed in a ball mill, and employed as a coating liquid. Both of the fluorescent materials were in the form of powders; a uniform coating liquid without aggregates was obtained by the dispersion in a ball mill.

### Fluorescent Material Dispersion B

| | |
|---|---|
| Fluorescent material 1 (emission maximum: 535 nm) | 1.0 weight part |
| Fluorescent material 2 (emission maximum: 650 nm) | 3.0 weight parts |
| Lauryl methacrylate | 99.0 weight parts |
| Photo-radical polymerization initiator | 1.0 weight part |
| (Irgacure (Japanese registered trademark) | |
| 819 (made by BASF)) | |

The following fluorescent materials were employed as fluorescent materials 1 and 2.

Fluorescent material 1 (SrGa2S4:Eu, HPL63/F-F1 made by U-VIX Corporation): Fluorescent half width 52 nm

Fluorescent material 2 (CaS:Eu, FL63/S-D1 made by U-VIX Corporation): Fluorescent half width 60 mu

3. Preparation of Composition for Forming the Member that Selectively Reduces an Amount of Emitted Light

### Preparation Example 3

Composition C below was prepared as a composition for forming an absorptive member that selectively reduces an amount of emitted light, filtered through a filter made of polypropylene having a 0.2 μm pore diameter, and employed as a coating liquid.

Composition C for Forming an Absorptive Member that Selectively Reduces an Amount of Emitted Light

| | |
|---|---|
| Phthalocyanine dye A | 5.0 weight parts |
| KAYARAD (Japanese registered trademark) DPHA | 5.8 weight parts |
| (polymerizable compound made by Nippon | |
| Kayaku Co., Ltd.) | |
| Acrybase FF-187 | 5.8 weight parts |
| (acrylic binder made by Fujikura Kasei Co., Ltd.) | |
| Photo-radical polymerization initiator | 0.2 weight part |
| (Irgacure (Japanese registered trademark) 819 | |
| (made by BASF)) | |
| Propylene glycol monomethyl ether acetate | 48.3 weight parts |

Phthalocyanine dye A shown in Table 1 above was employed as phthalocyanine dye A. Phthalocyanine dye A synthesized by the method described in paragraph 0233 of Japanese Unexamined Patent Publication (KOKAI) No. 2013-182028 was employed.

### Preparation Example 4

The following two compositions D1 and D2 were prepared as compositions for forming reflective members that selectively reduce an amount of emitted light.

Composition D1 was fabricated by referring to Fujifilm Research Report No. 50 (2005), pp. 60 to 63, which is expressly incorporated herein by reference in its entirety, and adjusting the quantity of chiral agent added.

Composition D2 was fabricated in the same manner as composition D1 with the exception that a chiral agent of the reverse optical rotation axis was employed. By using composition D2, it was possible to form a layer in which was fixed a cholesteric liquid crystal phase exhibiting the opposite optical rotational characteristics from the cholesteric liquid crystal phase immobilized in the layer formed using composition D1.

In compositions D1 and D2, cholesteric liquid crystal compounds in the form of rod-like liquid crystal compounds were employed.

### Preparation Example 5

The following compositions R1 and R2 were prepared as compositions for forming reflective members that selectively reduce an amount of emitted light. In composition R1, the following rod-like liquid crystal compound was employed as the cholesteric liquid crystal compound. In composition R2, the following disk-like liquid crystal compound was employed as the cholesteric liquid crystal compound.

Composition R1 was prepared by mixing the following components.

Composition R1 for Forming a Reflective Member that Selectively Reduces an Amount of Emitted Light

| | | |
|---|---|---|
| (Solutes) | | |
| Rod-like liquid crystal compound (compound 11 | 80 | weight parts |
| below) | | |
| Rod like liquid crystal compound (compound 12 | 20 | weight parts |
| below) | | |
| Fluorine horizontal orientation agent 1 indicated | 0.1 | weight part |
| below | | |
| Fluorine horizontal orientation agent 2 indicated | 0.007 | weight part |
| below | | |
| Right-handed chiral agent LC756 (made by | 3.0 | weight parts |
| BASF Corp.) | | |
| Polymerization initiator Irgacure 819 (made by | 3.0 | weight parts |
| BASF Corp.) | | |
| (Solvent) | | |

| | |
|---|---|
| Methyl ethyl ketone | Quantity yielding |
| | a 30 weight % |
| | concentration of |
| | above solutes in |
| | composition R1 |

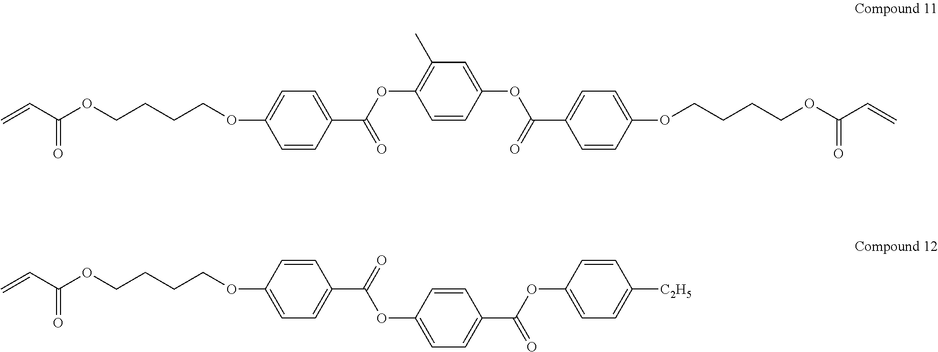

### Fluorine Horizontal Orientation Agent 1

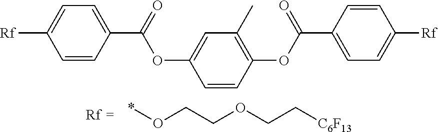

### Fluorine Horizontal Orientation Agent 2

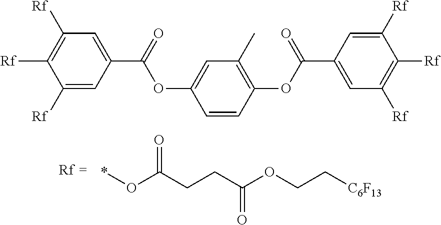

Composition R2 was prepared by mixing the following components.

Composition R2 for Forming a Reflective Member that Selectively Reduces an Amount of Emitted Light

| | |
|---|---|
| (Solutes) | |
| Disk-like liquid crystal compound (compound 1 | 35 weight parts |
| below) | |
| Disk-like cholesteric liquid crystal compound | 35 weight parts |
| (compound 2 below) | |
| Left-handed chiral agent (compound 3 below) | 35 weight parts |
| Orientation adjuvant (compound 4 below) | 1 weight part |
| Orientation adjuvant (compound 5 below) | 1 weight part |
| Polymerization initiator (compound 6 below) | 3 weight parts |
| (Solvent) | |
| Mixed solvent of 98:2 weight ratio of | Quantity yielding a |
| CH₂Cl₂ and C₂H₅OH | 30 weight % |
| | concentration of above |
| | solutes in composition |
| | R2 |

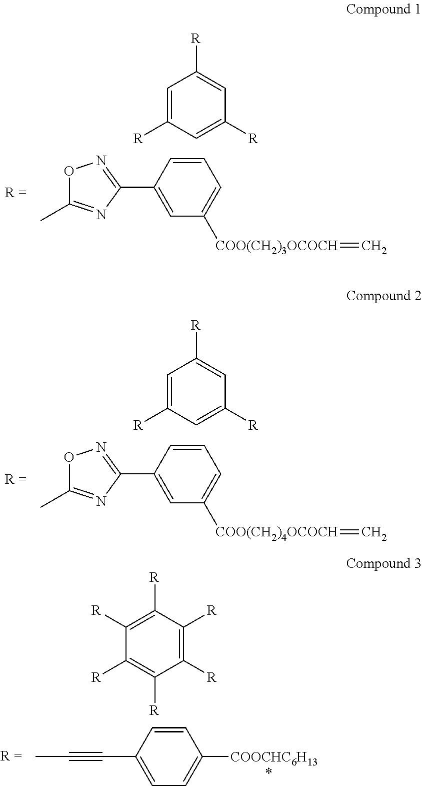

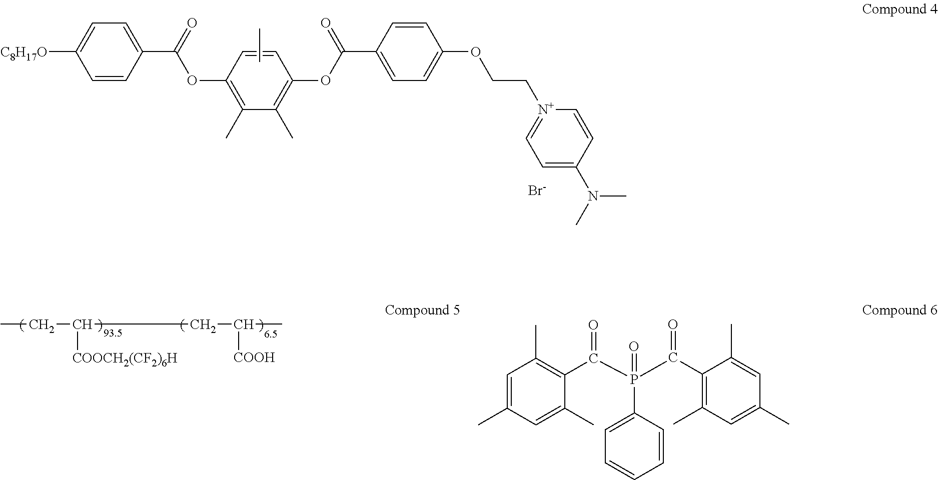

(Mixture of two compounds with a different substitution site of a methyl group on the trimethyl-substituted benzene ring in the following structural formula, mixing ratio of the two compounds (weight ratio): 50:50)

4. Fabrication of Barrier Film Having a Layer that Selectively Reduces an Amount of Emitted Light

Composition C was coated and dried on the surface of barrier film 10 (referred to as the “barrier layer”, hereinafter) on the side on which the first organic layer and inorganic layer had not been formed. The composition was then cured (UV radiation cured) by irradiation with ultraviolet radiation to fabricate a barrier film 21 having an absorptive layer selectively reducing an amount of emitted light. The thickness of the absorptive layer selectively reducing an amount of emitted light was about 2 μm and the maximum absorption wavelength was 682 nm.

Composition D1 was coated and dried on the surface of barrier film 10 on the side on which the barrier layer had not been formed. A cholesteric phase was formed by aging, after which the composition was cured by irradiation with ultraviolet radiation. Thereover, composition D2 was similarly coated, a cholesteric phase was formed, and UV radiation curing was conducted to prepare a barrier film 22 having a reflective layer selectively reducing an amount of emitted light. The thickness of the reflective layer selectively reducing an amount of emitted light was about 2 μm and the maximum reflection wavelength was 685 nm.

A dielectric multilayered film was formed as a multilayered vapor deposition film with a total of 29 layers having the repeating structure of TiO₂/SiO₂/ . . . /SiO₂/TiO₂ using a vapor deposition device on the surface of barrier film 10 on the side on which the barrier layer had not been formed. The thickness of each film was adjusted to prepare a barrier film 23 having a reflective layer selectively reducing an amount of emitted light. The maximum reflection wavelength was 685 nm.

5. Preparation of a Film (For Use as an Absorptive Member that Selectively Reduces an Amount of Emitted Light or a Selective Absorption Member) Having a Layer (Selective Absorption Layer) that Selectively Absorbs the 680 nm to 730 Wavelength Range

Composition C was coated, dried, and then UV radiation cured on a triacetyl cellulose film (Fujitac (Japanese registered trademark) TD40UC made by FUJIFILM) to fabricate a film 24 having a selective absorption layer. The thickness of the selective absorption layer was about 2 μm.

6. Fabrication of Bather Film Having Selective Reflection Layer

A barrier film 25 having a selective reflection layer having maximum reflection wavelengths of 490 nm and 580 nm was fabricated using a combination of cholesteric liquid crystal containing compositions in which the quantity of chiral agent and optical rotation axis had been changed by referencing Fujifilm Research Report No. 50 (2005), pp. 60 to 63, on the surface of barrier film 10 on the side on which the barrier layer had not been formed on. The thickness of the selective reflection layer was about 4 μm.

Further, a dielectric multilayered film was formed as a 59-layer multilayered film having a repeating structure of TiO₂/SiO₂/ . . . /SiO₂/TiO₂ using a vapor deposition device on the surface of barrier film 10 on the side on which the barrier layer had not been formed. The thickness of the various layers was adjusted and a barrier film 26 having a selective reflection layer having maximum reflection wavelengths of 490 nm and 580 nm was formed.

7. Fabrication of Barrier Film Having Absorptive Layer Selectively Reducing an Amount of Emitted Light and Selective Reflection Layer

Composition C was coated and dried on the selective reflection layer of barrier film 25 fabricated above. UV radiation curing was then conducted to provide an absorptive layer selectively reducing an amount of emitted light. By means of the above, a barrier film 27 was prepared that sequentially had a selective reflection layer and an absorptive layer selectively reducing an amount of emitted light on the surface of barrier film 10 on the side on which the barrier layer had not been formed.

8. Fabrication of Barrier Film Having a Reflective Layer with the Functions of Both a Reflective Layer Selectively Reducing an Amount of Emitted Light and a Selective Reflection Layer

A dielectric multilayered film was formed as an 89-layer multilayered film having a repeating structure of TiO₂/SiO₂/ . . . /SiO₂/TiO₂ using a vapor deposition device on the surface of barrier film 10 on the side on which the barrier film had not been formed. The thickness of the various layers was adjusted and a barrier film 28 having a reflective layer with the functions of both a reflective layer selectively reducing an amount of emitted light and a selective reflection layer, and having maximum reflection wavelengths of 490 nm, 580 nm, and 680 nm, was fabricated.

9. Fabrication of a Barrier Film Having a Reflective Layer Selectively Reducing an Amount of Emitted Light and a Selective Reflection Layer

Composition D1 was coated and dried on the selective reflection layer of barrier film 25. A cholesteric phase was then formed by aging, the composition was cured by irradiation with UV radiation, composition D2 was similarly coated thereover, a cholesteric liquid crystal phase was formed, and UV radiation curing was conducted to provide a reflective layer selectively reducing an amount of emitted light with a two-layer lamination of light-reflecting layers in which the cholesteric liquid crystal phase of a rod-like liquid crystal compound had been fixed. By means of the above, a barrier film 29 was fabricated that sequentially had a selective reflection layer and a reflective layer selectively reducing an amount of emitted light on the side of barrier film 10 on which the barrier layer had not been formed.

10. Fabrication of Barrier Film Having Layer Selectively Reducing an Amount of Emitted Light

Composition R1 was coated, a cholesteric liquid crystal phase was formed, and UV radiation curing was conducted on the surface of barrier film 10 on the side on which the barrier layer had not been formed, forming a light-reflecting layer in which a cholesteric liquid crystal phase of a rod-like liquid crystal compound was fixed.

Poval PVA-103 made by Kuraray was adjusted to a concentration that would yield a film thickness upon drying of 0.5 μm and dissolved in pure water. The coating liquid thus prepared was bar coated on the light-reflecting layer that had been formed. It was then heated for 5 minutes at 100° C. The surface of the coating film, thus formed was subjected to rubbing to form an orientation film.

Composition R2 was coated on the orientation film that had been formed, placed for 2 minutes in a heating furnace with an atmospheric temperature of 70° C. to vaporize the solvent, and then aged by heating for 4 minutes in a heating furnace at an atmospheric temperature of 100 ° C. to form a coating film. Subsequently, the coating film was placed within a heating furnace at an atmospheric temperature of 80° C., and then irradiated with UV radiation with a high-pressure mercury lamp in a nitrogen atmosphere to form a light-reflecting layer in which a cholesteric liquid crystal phase of disk-like liquid crystal compound was fixed.

By means of the above, a reflective layer selectively reducing an amount of emitted light was formed in which a light-reflecting layer in which a cholesteric liquid crystal phase of a rod-like liquid crystal compound was fixed and a light-reflecting layer in which a cholesteric liquid crystal phase of disk-like liquid crystal compound was fixed were laminated through an orientation layer.

In this manner, a barrier film 30 having a reflective layer selectively reducing an amount of emitted light was fabricated on the surface of barrier film 10 on which the barrier layer had not been formed.

11. Fabrication of Member with Wavelength Conversion Layer

### Manufacturing Example 3

Barrier film 10 fabricated by the procedure set forth above was employed as the first film and barrier film 21 was employed as the second film. Based on the manufacturing process set forth above with reference to FIGS. 2 and 3, a wavelength conversion member A was obtained. Specifically, a barrier film 10 was prepared as the first film. While being continuously conveyed at 1 m/min and a tension of 60 N/m, fluorescent material dispersion A was coated with a die coater on the surface of the inorganic layer and a coating 50 μm in thickness was formed. Next, barrier film 10 on which the coating had been formed was wound on a backup roller. On the coating, a second film in the form of barrier film 21, on which had been provided an absorptive layer selectively reducing an amount of emitted light, was laminated with the inorganic layer surface thereof facing the coating. Subsequently, with the coating sandwiched between the two barrier films (the first and second films), the assembly was wound on the backup roller. While being continuously conveyed, it was irradiated with UV radiation. The diameter of the backup roller was φ300 mm and the temperature of the backup roller was 50° C. The dose of UV radiation was 2,000 mJ/cm². This irradiation with UV radiation cured the coating and formed a cured layer (wavelength conversion layer), manufacturing wavelength conversion member A. The thickness of the cured layer of the wavelength conversion member was about 50 μm. Thus, a member A (member 3 having a wavelength conversion layer and absorptive layer selectively reducing an amount of emitted light) in which a wavelength conversion member and an absorptive member selectively reducing an amount of emitted light had been integrally laminated was obtained.

### Manufacturing Examples 1, 2, 4 to 19

Members 1, 2, and 4 to 19 were fabricated in the same manner as Manufacturing Example 3 with the exception that fluorescent material dispersions and barrier films were employed in the combinations given in Table 2 below.

TABLE 2

| | | Manufacturing Ex. 1 | | Manufacturing Ex. 2 | Manufacturing Ex. 3 | Manufacturing Ex. 4 | Manufacturing Ex. 5 |
|---|---|---|---|---|---|---|---|
| | | Member 1 | | Member 2 | Member 3 | Member 4 | Member 5 |
| Barrier film on light source side | | 10 | | 10 | 10 | 10 | 10 |
| Fluorescent material dispersion | | A | | A | A | A | A |
| Barrier film | Type | 10 | | 26 | 21 | 22 | 23 |
| on emission side | Configuration | — | | With | With absorptive layer | With reflective layer | With reflective layer |
| | | | | selective reflection | selectively reducing | selectively reducing | selectively reducing |
| | | | | layer | an amount of | an amount of | an amount of |
| | | | | | emitted light | emitted light | emitted light |
| | | Manufacturing Ex. 6 | | Manufacturing Ex. 7 | Manufacturing Ex. 8 | Manufacturing Ex. 9 | Manufacturing Ex. 10 |
| | | Member 6 | | Member 7 | Member 8 | Member 9 | Member 10 |
| Barrier film on light source side | | 10 | | 10 | 10 | 10 | 10 |
| Fluorescent material dispersion | | A | | A | A | A | B |
| Barrier film | Type | 27 | | 28 | 29 | 25 | 10 |
| on emission side | Configuration | With absorptive layer | | With reflection layer having functions of | With reflection layer selectively reducing | With selective | — |
| | | selectively reducing | | reflective layer selectively reducing | an amount of emitted light | reflection layer | |
| | | an amount of emitted light | | an amount of emitted light | and selective reflection layer | | |
| | | and selective reflection layer | | and selective reflection layer | | | |
| | | Manufacturing Ex. 11 | | Manufacturing Ex. 12 | Manufacturing Ex. 13 | Manufacturing Ex. 14 | Manufacturing Ex. 15 |
| | | Member 11 | | Member 12 | Member 13 | Member 14 | Member 15 |
| Barrier film on light source side | | 10 | | 10 | 10 | 10 | 10 |
| Fluorescent material dispersion | | B | | B | B | B | B |
| Barrier film | Type | 26 | | 21 | 22 | 23 | 27 |
| on emission side | Configuration | With selective | | With absorptive layer | With reflective layer | With reflective layer | With absorptive layer selectively |
| | | reflection layer | | selectively reducing | selectively reducing | selectively reducing | reducing an amount of emitted light |
| | | | | an amount of | an amount of emitted light | an amount of | and selective reflection layer |
| | | | | emitted light | | emitted light | |
| | | | | Manufacturing Ex. 16 | Manufacturing Ex. 17 | Manufacturing Ex. 18 | Manufacturing Ex. 19 |
| | | | | Member 16 | Member 17 | Member 18 | Member 19 |
| | | Barrier film on light source side | | 10 | 10 | 10 | 10 |
| | | Fluorescent material dispersion | | B | B | B | A |
| | | Barrier film | Type | 28 | 29 | 25 | 30 |
| | | on emission side | Configuration | With reflection layer having functions of | With reflective layer | With selective | With reflective layer |
| | | | | reflective layer selectively reducing | selectively reducing | reflection layer | selectively reducing |
| | | | | an amount of emitted light | an amount of emitted light | | an amount of |
| | | | | and selective reflection layer | and selective reflection layer | | emitted light |

11. Fabrication of Liquid Crystal Display Device

A commercial liquid crystal display device (product name THL42D2, made by Panasonic) was dismantled. In addition to adding the members fabricated in the various Manufacturing Examples and, as needed, film 24 to the structure between the liquid crystal panel and the light guide plate, the backlight unit was replaced with a backlight unit equipped with the blue light source set forth below. The backlight units of Examples and Comparative Examples, and liquid crystal display devices incorporating these backlight units, were manufactured. These backlight units were equipped with a light source in the form of a blue light-emitting diode (Nichia B-LED: Blue, main wavelength 465 nm, half width 20 nm). In the course of disposing the various members within the backlight units, the barrier films on the front and back of the various members were positioned relative to the light source side and emission side of the liquid crystal display device into which the backlight units were incorporated in the manner set forth in Table 2. The polarizing plate that had been attached to the liquid crystal panel was left in place and used without alteration.

The various members indicated in Table 3 were simply positioned on the light guide plate, without being adhered coating.

When film 24 is described as being adjacent on the light source side of the liquid crystal panel in Table 3, it was disposed between the member and the liquid crystal panel (simply positioned on the member). When described as being between the light guide plate and the member, it was simply placed on the light guide plate, and the member was simply placed on it.

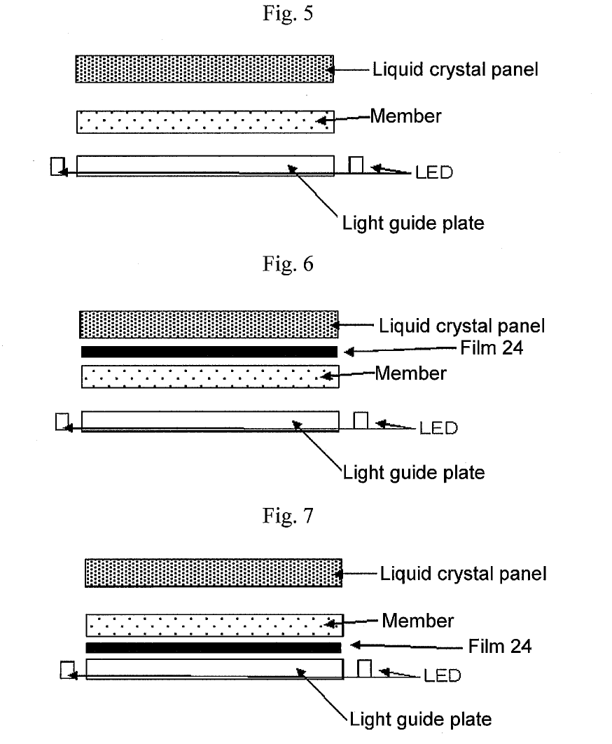

FIG. 5 shows a schematic drawing of the configuration of the liquid crystal display devices of Examples 1 to 3, 6 to 8, 11 to 13, 16 to 18, and 21, and Comparative Examples 1 to 6.

FIG. 6 shows a schematic drawing of the configuration of the liquid crystal display devices of Examples 4, 9, 14, and 19.

FIG. 7 shows a schematic drawing of the configurations of the liquid crystal display devices of Examples 5, 10, 15, and 20.

In FIGS. 5 to 7, rendering of the structural members of the backlight unit (diffusion plate, reflection plate, brightness-enhancement plate, and the like) and the structural members of the liquid crystal display panel (liquid crystal cell, polarizing plates, protective plate, and the like) has been omitted.

TABLE 3

| | Ex. 1 | Ex. 2 | Ex. 3 | Ex. 4 | Ex. 5 |
|---|---|---|---|---|---|
| Member | Member 3 | Member 5 | Member 7 | Member 2 | Member 7 |
| Position of | Not | Not | Not | Being adjacent | Between |
| Film 24 | included | included | included | on the light | the light |
| | | | | source side | guide plate |
| | | | | of the liquid | and the |
| | | | | crystal panel | wavelength |
| | | | | (Film 24: absorptive | conversion |
| | | | | member selectively | member |
| | | | | reducing an amount | (Film 24: selective |
| | | | | of emitted light) | absorption member) |
| Schematic drawing of configuration | FIG. 5 | FIG. 5 | FIG. 5 | FIG. 6 | FIG. 7 |
| of liquid crystal display device | | | | | |

| | Ex. 6 | Ex. 7 | Ex. 8 | Ex. 9 | Ex. 10 |
|---|---|---|---|---|---|
| Member | Member 4 | Member 6 | Member 8 | Member 9 | Member 8 |
| Position of | Member | Not | Not | Being adjacent | Between |
| Film 24 | Not | included | included | on the light | the light |
| | included | | | source side | guide plate |
| | | | | of the liquid | and the |
| | | | | crystal panel | wavelength |
| | | | | (Film 24: absorptive | conversion |
| | | | | member selectively | member |
| | | | | reducing an amount | (Film 24: selective |
| | | | | of emitted light) | absorption member) |
| | FIG. 5 | FIG. 5 | FIG. 5 | FIG. 6 | FIG. 7 |

| | Ex. 11 | Ex. 12 | Ex. 13 | Ex. 14 | Ex. 15 |
|---|---|---|---|---|---|
| Member | Member 12 | Member 14 | Member 16 | Member 11 | Member 16 |
| Position of | Not | Not | Not | Being adjacent | Between |
| Film 24 | included | included | included | on the light | the light |
| | | | | source side | guide plate |
| | | | | of the liquid | and the |
| | | | | crystal panel | wavelength |
| | | | | (Film 24: absorptive | conversion |
| | | | | member selectively | member |
| | | | | reducing an amount | (Film 24: selective |
| | | | | of emitted light) | absorption member) |
| | FIG. 5 | FIG. 5 | FIG. 5 | FIG. 6 | FIG. 7 |

| | Ex. 16 | Ex. 17 | Ex. 18 | Ex. 19 | Ex. 20 | Ex. 21 |
|---|---|---|---|---|---|---|
| Member | Member 13 | Member 15 | Member 17 | Member 18 | Member 17 | Member 19 |
| Position of | Not | Not | Not | Being adjacent | Between | Not |
| Film 24 | included | included | included | on the light | the light | included |
| | | | | source side | guide plate | |
| | | | | of the liquid | and the | |
| | | | | crystal panel | wavelength | |
| | | | | (Film 24: absorptive | conversion | |
| | | | | member selectively | member | |
| | | | | reducing an amount | (Film 24: selective | |
| | | | | of emitted light) | absorption member) | |
| Schematic drawing | FIG. 5 | FIG. 5 | FIG. 5 | FIG. 6 | FIG. 7 | FIG. 5 |
| of configuration of | | | | | | |
| liquid crystal display device | | | | | | |

| | Comp. Ex. 1 | Comp. Ex. 2 | Comp. Ex. 3 | Comp. Ex. 4 | Comp. Ex. 5 | Comp. Ex. 6 |
|---|---|---|---|---|---|---|
| Member | Member 2 | Member 9 | Member 1 | Member 11 | Member 18 | Member 10 |
| Position of | Not | Not | Not | Not | Not | Not |
| Film 24 | included | included | included | included | included | included |
| Schematic drawing of configuration | FIG. 5 | FIG. 5 | FIG. 5 | FIG. 5 | FIG. 5 | FIG. 5 |
| of liquid crystal display device | | | | | | |

12. Evaluation Methods

### <Evaluation of Color Reproducibility Range>

In the liquid crystal display devices of Examples and Comparative Examples that were fabricated, the red pixels alone, green pixels alone, and blue pixels alone were successively lit up, and their respective chromaticity was measured with a BM-5A color luminance meter made by Topcon Techno House, Inc. The chromaticity points of the red, green, and blue colors measured by the above method were joined on an xy chromaticity diagram to produce a triangular area. This area was then divided by the area of a triangle formed by joining the three primary color points on the NTSC standard to calculate an NTSC ratio (%).

The values given for the peak wavelengths (emission center wavelengths) and half width of green and red light in Table 6 were measured using a luminance meter (SR-3 made by TOPCON) in spectrum measurement mode using the same setup as when measuring the above NTSC ratio.

### <Brightness Evaluation>

The brightness was measured with a luminance meter (SR-3 made by TOPCON) positioned 740 mm perpendicularly from the display surface of the liquid crystal display devices fabricated in Examples and Comparative Examples. The brightness of Comparative Example 1 was adopted as 1.00, and the relative value (arbitrary unit: a.u.) of each of Examples and Comparative Examples was evaluated relative to Comparative Example 1.

### <Rise in Temperature of the Member>

During the fabrication of the liquid crystal device, a thermocouple was bonded onto the member (member having a wavelength conversion layer) of Each of Examples and Comparative Examples. Continuous lighting of white display was conducted for 24 hours under the constant temperature of 25° C. and the constant humidity of 60% relative humidity, and the average temperature of the last 6 hours was measured. Evaluation was conducted under the following standard.

A: Average temperature less than 50° C.

B: Average temperature greater than or equal to 50° C. but less than 55° C.

C: Average temperature greater than or equal to 55° C. but less than 60° C.

D: Average temperature greater than or equal to 60° C.

<Difference in Color Observed from Directly in Front of Display Surface and Color Observed from a Diagonal Orientation (Color Unevenness with Diagonal Orientation)>

The difference (color unevenness) in the color observed from directly in front of the display surface and the color observed from a diagonal orientation was evaluated by the following method for the liquid crystal display devices of Examples 1, 2, 6, and 21 and Comparative Example 3. In the measurement of color coordinates u′v′ below, an EZ-Contrast 160D made by ELDI Corporation was employed as the measurement apparatus.

The color differential Δu′v′ of the difference between the values of color coordinates u′v′ measured directly in front (0 degree polar angle) and the values of color coordinates u′v′ measured at a 60 degree polar angle orientation was measured for orientation angles of 0 to 360 degrees. The average value was adopted as the evaluation index of the color unevenness with diagonal orientation. Based on the results, the color unevenness with diagonal orientation was evaluated based on the following standard:

A: 10% or more greater than the color unevenness with diagonal orientation of the liquid crystal display device of Comparative Example 3

B: More than 0% but less than 10% greater than the color unevenness with diagonal orientation of the liquid crystal display device of Comparative Example 3

C: Less than or equal to the color unevenness with diagonal orientation of the liquid crystal display device of Comparative Example 3

13. Evaluation Results

The evaluation results for the above Examples and Comparative Examples are given in Tables 4 to 6.

Specifically, Table 4 gives the results of comparison of Examples that had a layer selectively reducing an amount of emitted light to Comparative Examples, which did not.

Table 5 gives the results of comparison of Examples that had a layer selectively reducing an amount of emitted light and a selective reflection layer to Comparative Examples that did not have a layer selectively reducing an amount of emitted light.

Table 6 gives the results of measurement of Examples and Comparative Examples for which the peak wavelength (emission center wavelength) and half width of green light and red light were measured.

TABLE 4

| | Ex. 1 | Ex. 2 | Ex. 6 | Comp. Ex. 3 | Ex. 21 |
|---|---|---|---|---|---|
| Fluorescent material | A | A | A | A | A |
| dispersion | | | | | |
| NTSC ratio (%) | 85% | 85% | 83% | 75% | 83% |
| Brightness (a.u.) | 0.99 | 0.99 | 0.99 | 1.00 | 0.99 |
| Rise in temperature | B | A | A | A | A |
| of the member | | | | | |
| Color unevenness | C | C | C | C | A |
| with diagonal orientation | | | | | |

| | Ex. 11 | Ex. 12 | Ex. 16 | Comp. Ex. 6 |
|---|---|---|---|---|
| Fluorescent material | B | B | B | B |
| dispersion | | | | |
| NTSC ratio (%) | 70% | 70% | 69% | 65% |
| Brightness (a.u.) | 0.79 | 0.79 | 0.79 | 0.80 |
| Rise in temperature | B | A | A | A |
| of the member | | | | |

In the results given in Table 4, when Examples and Comparative Examples in which the same fluorescent material dispersions had been employed were compared, Examples having a layer selectively reducing an amount of emitted light were found to have an expanded color reproducibility range relative to Comparative Examples. This was accompanied by only a slight decrease in brightness of nearly negligible degree.

A comparison of the color unevenness with diagonal orientation in Examples 1, 2, 6, and 21 and Comparative Example 3 indicated that in Example 21, by means of a reflective member selectively reducing an amount of emitted light, in which were laminated a light-reflecting layer in which a cholesteric liquid crystal phase of a rod-like liquid crystal compound was fixed and a light-reflecting layer in which a cholesteric liquid crystal phase of a disk-like liquid crystal compound was fixed, the color unevenness with diagonal orientation was improved. The color unevenness with diagonal orientation in Examples 1, 2, and 6 was of a level that presented no impediment to practical use.

TABLE 5

| | Ex. 3 | Ex. 4 | Ex. 5 | Comp. Ex. 1 | Ex. 7 | Ex. 8 | Ex. 9 | Ex. 10 | Comp. Ex. 2 |
|---|---|---|---|---|---|---|---|---|---|
| Fluorescent material dispersion | A | A | A | A | A | A | A | A | A |
| NTSC ratio (%) | 95% | 95% | 95% | 85% | 92% | 92% | 92% | 92% | 85% |
| Brightness (a.u.) | 1.00 | 0.99 | 1.00 | 1.00 | 0.99 | 1.00 | 0.99 | 1.00 | 1.00 |
| Rise in temperature of the member | A | A | A | A | B | A | A | A | A |
| | Ex. 13 | Ex. 14 | Ex. 15 | Comp. Ex. 4 | Ex. 17 | Ex. 18 | Ex. 19 | Ex. 20 | Comp. Ex. 5 |
| Fluorescent material dispersion | B | B | B | B | B | B | B | B | B |
| NTSC ratio (%) | 85% | 85% | 85% | 80% | 83% | 83% | 83% | 83% | 80% |
| Brightness (a.u.) | 0.80 | 0.79 | 0.80 | 0.80 | 0.79 | 0.80 | 0.79 | 0.80 | 0.80 |
| Rise in temperature of the member | A | A | A | A | B | A | A | A | A |

In the results given in Table 5, when Examples and Comparative Examples in which the same fluorescent material dispersions had been employed were compared, Examples having both a layer selectively reducing an amount of emitted light and a selective reflection layer were found to have an expanded color reproducibility range relative to Comparative Examples. This was accompanied by only a slight decrease in brightness of nearly negligible degree. In Examples given in Table 5, the fact that the fluorescent materials contained in the wavelength conversion layer were excited with the light that was reflected by the selective reflection layer and entered the wavelength conversion layer, and that these fluorescent materials then emitted red light and green light, was thought to contribute to inhibiting a decrease in brightness. Further, compared to Examples shown in Table 4, in which identical fluorescent material dispersions were employed, the color reproducibility range was determined to have been further expanded by the presence of a layer selectively reducing an amount of emitted light and a selective reflection layer.

As shown in Tables 4 and 5, Examples having an absorptive layer reducing an amount of emitted light received an evaluation result of B for the rise in temperature of the member. However, Examples having a reflective layer reducing an amount of emitted light received an evaluation result of A for the rise in temperature of the member. The small rise in temperature of members containing such a wavelength conversion layer was desirable in backlight units having a wavelength conversion layer the emission efficiency of which decreased due to heat.

TABLE 6

| | Ex. 1 | Ex. 2 | Ex. 6 | Comp. Ex. 3 | Ex. 11 | Ex. 12 | Ex. 16 | Comp. Ex. 6 |
|---|---|---|---|---|---|---|---|---|
| Fluorescent material dispersion | A | A | A | A | B | B | B | B |
| Peak wavelength of green light (nm) | 520 | 520 | 520 | 520 | 535 | 535 | 535 | 535 |
| Half width of green light (nm) | 65 | 65 | 65 | 65 | 52 | 52 | 52 | 52 |
| Peak wavelength of red light (nm) | 630 | 630 | 630 | 630 | 650 | 650 | 650 | 650 |
| Half width of red light (nm) | 42 | 42 | 45 | 70 | 28 | 28 | 32 | 60 |
| | Ex. 3 | Ex. 4 | Ex. 5 | Ex. 7 | Ex. 8 | Ex. 9 | Ex. 10 | Comp. Ex. 3 |
| Fluorescent material dispersion | A | A | A | A | A | A | A | A |
| Peak wavelength of green light (nm) | 520 | 520 | 520 | 520 | 520 | 520 | 520 | 520 |
| Half width of green light (nm) | 45 | 45 | 45 | 49 | 49 | 49 | 49 | 65 |
| Peak wavelength of red light (nm) | 630 | 630 | 630 | 630 | 630 | 630 | 630 | 630 |
| Half width of red light (nm) | 42 | 42 | 42 | 45 | 45 | 45 | 45 | 70 |
| | Ex. 13 | Ex. 14 | Ex. 15 | Ex. 17 | Ex.18 | Ex. 19 | Ex. 20 | Comp. Ex. 6 |
| Fluorescent material dispersion | B | B | B | B | B | B | B | B |
| Peak wavelength of green light (nm) | 535 | 535 | 535 | 535 | 535 | 535 | 535 | 535 |
| Half width of green light (nm) | 42 | 42 | 42 | 42 | 42 | 42 | 42 | 52 |
| Peak wavelength of red light (nm) | 650 | 650 | 650 | 650 | 650 | 650 | 650 | 650 |
| Half width of red light (nm) | 28 | 28 | 28 | 32 | 32 | 32 | 32 | 60 |

Comparative Examples 3 and 6 did not have layers selectively reducing an amount of emitted light. Thus, the half width of the red light and green light in these Comparative Examples was the half width of the red light and green light emitted by the fluorescent materials contained in the wavelength conversion layer.

As shown in Table 6, in Examples having a layer selectively reducing an amount of emitted light but not having a selective reflection layer, the half width of the red light peak was narrower than that of Comparative Examples in which the same fluorescent material dispersions were employed (Comparative Examples 3 and 6). Thus, the presence of a layer selectively reducing an amount of emitted light was determined to render the half width of red light narrower.

In Examples having both a layer selectively reducing an amount of emitted light and a selective reflection layer, in addition to the half width of the red light peak, the half width of the green light peak was found to have become narrower.

The fact that the half width was rendered narrow in the manner set forth above was thought to contribute to the expansion of the color reproducibility range (enhanced NTSC ratios) indicated in Tables 4 and 5 above.

The present invention is useful in the field of manufacturing liquid crystal display devices.

The present disclosure relates to the subject matter contained in Japanese Patent Application No. 2014-133363 filed on Jun. 27, 2014, Japanese Patent Application No. 2014-245205 filed on Dec. 3, 2014 and Japanese Patent Application No. 2015-099718 filed on May 15, 2015, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A backlight unit, which comprises:
at least a light-emitting element and a member that selectively reduces an amount of emitted light; and wherein
the light-emitting element comprises a light source and a wavelength conversion member, and the wavelength conversion member comprises at least one fluorescent material having a property of being excited with exciting light to emit fluorescence;
the light-emitting element has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm; with at least the green light and the red light being emitted by the fluorescent material; and
the member that selectively reduces an amount of emitted light is positioned on an optical path of the light emitted by the light-emitting element and has a capability of selectively reducing an amount of emitted light in a wavelength range of 680 nm to 730 nm in the light that is emitted by the light-emitting element and enters the member that selectively reduces an amount of emitted light.

2. The backlight unit according to claim 1, which further comprises a selective reflection member on the optical path of light emitted by the light-emitting element, and wherein
the selective reflection member has a reflection peak in a wavelength range of at least either a wavelength range between the emission center wavelength of the blue light and the emission center wavelength of the green light or a wavelength range between the emission center wavelength of the green light and the emission center wavelength of the red light.

3. The backlight unit according to claim 2, wherein the member that selectively reduces an amount of emitted light and the selective reflection member are separate members.

4. The backlight unit according to claim 2, wherein the member that selectively reduces an amount of emitted light and the selective reflection member are a single member.

5. The backlight unit according to claim 1, wherein the member that selectively reduces an amount of emitted light has a capability of selectively absorbing light in a wavelength range of 680 nm to 730 nm.

6. The backlight unit according to claim 5, wherein the member that selectively reduces an amount of emitted light comprises a dye that has a capability of absorbing light in a wavelength range of 680 nm to 730 nm.

7. The backlight unit according to claim 2, wherein the member that selectively reduces an amount of emitted light has a capability of selectively absorbing light in a wavelength range of 680 nm to 730 nm.

8. The backlight unit according to claim 7, wherein the member that selectively reduces an amount of emitted light comprises a dye that has a capability of absorbing light in a wavelength range of 680 nm to 730 nm.

9. The backlight unit according to claim 1, wherein the member that selectively reduces an amount of emitted light has a capability of selectively reflecting light in a wavelength range of 680 nm to 730 nm.

10. The backlight unit according to claim 9, wherein the member that selectively reduces an amount of emitted light is a multilayered film in which multiple layers of differing refractive index are laminated.

11. The backlight unit according to claim 10, wherein the member that selectively reduces an amount of emitted light is a light-reflecting layer in which a cholesteric liquid crystal phase is fixed.

12. The backlight unit according to claim 9, wherein the light-emitting element further comprises a selective absorption member having a capability of selectively absorbing light in an wavelength range of 680 nm to 730 nm.

13. The backlight unit according to claim 1, wherein the member that selectively reduces an amount of emitted light is integrally laminated with the wavelength conversion member.

14. The backlight unit according to claim 1, wherein the fluorescent material comprises at least one quantum dot.

15. The backlight unit according to claim 1, wherein the fluorescent material comprises at least one ceramic fluorescent material.

16. The backlight unit according to claim 1, wherein the light source is a light source that emits single peak light.

17. The backlight unit according to claim 16, wherein the light source is a blue light source that emits blue light.

18. A liquid crystal display device, which comprises at least a liquid crystal cell and a backlight unit, wherein the backlight unit comprises:
at least a light-emitting element and a member that selectively reduces an amount of emitted light; and wherein
the light-emitting element comprises a light source and a wavelength conversion member, and the wavelength conversion member comprises at least one fluorescent material having a property of being excited with exciting light to emit fluorescence;
the light-emitting element has a property of emitting blue light, green light, and red light, and the blue light has an emission intensity peak with an emission center wavelength falling within a wavelength range of 430 nm to 480 nm, the green light has an emission intensity peak with an emission center wavelength falling within a wavelength range of 520 nm to 560 nm and a half width exceeding 50 nm, and the red light has an emission intensity peak with an emission center wavelength falling within a wavelength range of 600 nm to 680 nm and a half width exceeding 50 nm; with at least the green light and the red light being emitted by the fluorescent material; and
the member that selectively reduces an amount of emitted light is positioned on an optical path of the light emitted by the light-emitting element and has a capability of selectively reducing an amount of emitted light in a wavelength range of 680 nm to 730 nm in the light that is emitted by the light-emitting element and enters the member that selectively reduces an amount of emitted light.

19. The liquid crystal display device according to claim 18, wherein the backlight unit further comprises a selective reflection member on the optical path of light emitted by the light-emitting element, and wherein
the selective reflection member has a reflection peak in a wavelength range of at least either a wavelength range between the emission center wavelength of the blue light and the emission center wavelength of the green light or a wavelength range between the emission center wavelength of the green light and the emission center wavelength of the red light.

20. The liquid crystal display device according to claim 18, wherein the member that selectively reduces an amount of emitted light has a capability of selectively reflecting light in a wavelength range of 680 nm to 730 nm.
